(19) United States
(12) Patent Application Publication
(10) Pub. No.: US 2024/0098570 A1
(43) Pub. Date: Mar. 21, 2024

(54) TECHNIQUES FOR DATA TRANSPORT IN A SERVICE-BASED WIRELESS SYSTEM

(71) Applicant: QUALCOMM Incorporated, San Diego, CA (US)

(72) Inventors: Aziz Gholmieh, Del Mar, CA (US); Miguel Griot, La Jolla, CA (US); Gavin Bernard Horn, La Jolla, CA (US)

(21) Appl. No.: 17/948,125

(22) Filed: Sep. 19, 2022

(51) Int. Cl. H04W 28/08; H04L 5/00; H04W 28/02; H04W 76/25

(52) U.S. Cl. CPC H04W 28/0967; H04L 5/0048; H04L 5/0098; H04W 28/0268; H04W 76/25

(57) ABSTRACT

Methods, systems, and devices for wireless communications are described. Described techniques relate to signaling between user equipment (UE), distributed units, and a transport service of a service-based network that provides radio bearers for multiple core network services of the service-based network. The transport service may enable the UE to establish and maintain connections with the various core network services offered by the service-based network. A UE may indicate requested parameters, such as quality of service (QoS) targets, an amount of data, and the like, and the transport service may return service information indicating core network services that match the request capabilities. A distributed unit may map one or multiple transport radio bearers to a logical channel, and provide a physical resource configuration to the UE for communicating with one or more core network services via the distributed unit.

### FIELD OF TECHNOLOGY

The following relates to wireless communications, including techniques for data transport in a service-based wireless system.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for data transport in a service-based wireless system. In accordance with various aspects of the present disclosure, signaling and other mechanisms are provided that enable a user equipment (UE) to establish wireless connections in a service-based network, such as a Sixth Generation (6G) network. In particular, aspects of the present disclosure may support signaling between UEs, network entities (e.g., distributed units (DUs)), and network services of a service-based network architecture (e.g., core network services, radio access network (RAN) services, or both) that enables the UEs to establish transport channels for wireless connections in a service-based cloud network (e.g., 6G network).

In accordance with various aspects, signaling may be provided between UEs, DUs, and one or more transport services of a service-based cloud network architecture that enable UEs to establish radio bearers (e.g., transport radio bearers), where one or more transport radio bearers are mapped to a logical channel for communications between a UE and DU. For example, a UE may establish a connection with a DU, and receive control signaling indicating a transport service is offered by the network. The UE may transmit (e.g., via the DU) a service request based on data to be transmitted, which may include quality of service (QoS) parameters (e.g., latency, reliability, timing of first packet, etc.). The transport service may communicate with the DU to configure scheduling, resources, and QoS requirements for the transport radio bearer. The DU may determine a radio configuration based on the information received from the transport service, such as physical (PHY) layer parameters (e.g., number of carriers, logical channel mapping to service layer transport radio bearers, uplink/downlink grants, etc.) and layer 2 (L2) parameters (e.g., medium access control (MAC) and radio link control (RLC) parameters, security parameters, packet data convergence protocol (PDCP) parameters, or any combinations thereof). The UE may communicate with the transport service via the DU based on the radio configuration. Dynamic updates may be made based on updated conditions at the UE, network, or both.

A method for wireless communications at a UE is described. The method may include communicating, via a distributed unit, a first service message to establish a first transport radio bearer with a first transport service offered by a service-based network, the first service message indicating one or more attributes associated with information to be transported via the first transport radio bearer, receiving, from the distributed unit in response to the first service message, a physical resource configuration for communications associated with the first transport service, and a mapping of the first transport radio bearer to a first channel between the UE and the distributed unit, and communicating, via the distributed unit based on the physical resource configuration, the information to be transported via the first transport service.

An apparatus for wireless communications at a UE is described. The apparatus may include a processor, memory coupled with the processor, and instructions stored in the memory. The instructions may be executable by the processor to cause the apparatus to communicate, via a distributed unit, a first service message to establish a first transport radio bearer with a first transport service offered by a service-based network, the first service message indicating one or more attributes associated with information to be transported via the first transport radio bearer, receive, from the distributed unit in response to the first service message, a physical resource configuration for communications associated with the first transport service, and a mapping of the first transport radio bearer to a first channel between the UE and the distributed unit, and communicate, via the distributed unit based on the physical resource configuration, the information to be transported via the first transport service.

Another apparatus for wireless communications at a UE is described. The apparatus may include means for communicating, via a distributed unit, a first service message to establish a first transport radio bearer with a first transport service offered by a service-based network, the first service message indicating one or more attributes associated with information to be transported via the first transport radio bearer, means for receiving, from the distributed unit in response to the first service message, a physical resource configuration for communications associated with the first transport service, and a mapping of the first transport radio bearer to a first channel between the UE and the distributed unit, and means for communicating, via the distributed unit based on the physical resource configuration, the information to be transported via the first transport service.

A non-transitory computer-readable medium storing code for wireless communications at a UE is described. The code may include instructions executable by a processor to communicate, via a distributed unit, a first service message to establish a first transport radio bearer with a first transport service offered by a service-based network, the first service message indicating one or more attributes associated with information to be transported via the first transport radio bearer, receive, from the distributed unit in response to the first service message, a physical resource configuration for communications associated with the first transport service, and a mapping of the first transport radio bearer to a first channel between the UE and the distributed unit, and communicate, via the distributed unit based on the physical resource configuration, the information to be transported via the first transport service.

Some examples of the method, apparatuses, and non-transitory computer-readable medium described herein may further include operations, features, means, or instructions for mapping one or more transport radio bearers to the first channel, each of the transport radio bearers having an associated transport service.

In some examples of the method, apparatuses, and non-transitory computer-readable medium described herein, the information to be transported via the first transport service may be split over two or more channels between the UE and the distributed unit, including a separate channel for signaling information. In some examples of the method, apparatuses, and non-transitory computer-readable medium described herein, the split over the two or more channels may be based on one or more of a traffic priority of the information to be transported via the first transport service, a traffic delay tolerance of the information to be transported via the first transport service, a traffic acceptable error rate of the information to be transported via the first transport service, or any combinations thereof.

In some examples of the method, apparatuses, and non-transitory computer-readable medium described herein, two or more transport radio bearers from the first transport service may be mapped to the first channel, one transport radio bearer may be mapped to the first channel, or multiple transport radio bearers may be mapped to each of two or more channels. In some examples of the method, apparatuses, and non-transitory computer-readable medium described herein, the first service message includes one or more quality of service targets associated with the information to be transported via the first transport service and different quality of service targets are associated with different channels between the UE and the distributed unit. In some examples of the method, apparatuses, and non-transitory computer-readable medium described herein, the information to be transported via the first transport service may be transmitted using a set of multiple packets, and each packet of the set of multiple packets include an indication of the first transport radio bearer. In some examples of the method, apparatuses, and non-transitory computer-readable medium described herein, the first transport radio bearer provides communications for both signaling information and data associated with the first transport service.

In some examples of the method, apparatuses, and non-transitory computer-readable medium described herein, the communicating the first service message may include operations, features, means, or instructions for communicating the one or more attributes associated with information to be transported via the first transport service as one or more quality of service parameters that include a latency target, a throughput target, a security level, or any combinations thereof. Some examples of the method, apparatuses, and non-transitory computer-readable medium described herein may further include operations, features, means, or instructions for communicating, via the distributed unit, one or more buffer status reports to the first transport service to maintain an active state at the first transport service.

Some examples of the method, apparatuses, and non-transitory computer-readable medium described herein may further include operations, features, means, or instructions for receiving an indication to throttle information to be transported via the first transport service and throttling the information communicated via the first transport service independently of an amount of information communicated via one or more other transport services that are different than the first transport service. Some examples of the method, apparatuses, and non-transitory computer-readable medium described herein may further include operations, features, means, or instructions for communicating, via the distributed unit, a second service message that indicates to deactivate the first transport radio bearer associated with the first transport service. Some examples of the method, apparatuses, and non-transitory computer-readable medium described herein may further include operations, features, means, or instructions for obtaining, subsequent to a deactivation of the first transport service, further information to be transported via the first transport radio bearer and communicating, via the distributed unit, a third service message to activate the first transport radio bearer.

In some examples of the method, apparatuses, and non-transitory computer-readable medium described herein, the third service message includes an indication of one or more of a buffer status report associated with the first transport radio bearer, a target delivery time for a first packet of data of the further information to be transported via the first transport radio bearer, or any combinations thereof. Some examples of the method, apparatuses, and non-transitory computer-readable medium described herein may further include operations, features, means, or instructions for communicating, via the distributed unit, a second service message that indicates to release the first transport radio bearer associated with the first transport service, where the second service message may be communicated responsive to a lack of information to be transported via the first transport radio bearer, an expiration of data associated with the first transport radio bearer, or any combinations thereof.

Some examples of the method, apparatuses, and non-transitory computer-readable medium described herein may further include operations, features, means, or instructions for receiving, from the distributed unit in response to an updated configuration associated with the first transport service, an updated physical resource configuration and communicating, via the distributed unit based on the updated physical resource configuration, the information to be transported via the first transport service. In some examples of the method, apparatuses, and non-transitory computer-readable medium described herein, the first transport service may be provided at a protocol layer associated with the first transport radio bearer and the protocol layer may be an Internet protocol (IP) layer or a packet data convergence protocol (PDCP) layer.

A method for wireless communications at a distributed unit is described. The method may include communicating a first service message between a UE and a first transport service offered by a service-based network, the first service message to establish the first transport service and indicating one or more attributes associated with information to be transported via the first transport service, receiving a radio access network configuration from the first transport service that indicates a first transport radio bearer and traffic flow information associated with the first transport radio bearer, transmitting, to the UE in response to the radio access network configuration, a physical resource configuration for communications associated with the first transport service, and a mapping of the first transport radio bearer to a first channel between the UE and the distributed unit, and communicating, based on the physical resource configuration, the information to be transported via the first transport service between the UE and the first transport service.

An apparatus for wireless communications at a distributed unit is described. The apparatus may include a processor, memory coupled with the processor, and instructions stored in the memory. The instructions may be executable by the processor to cause the apparatus to communicate a first service message between a UE and a first transport service offered by a service-based network, the first service message to establish the first transport service and indicating one or more attributes associated with information to be transported via the first transport service, receive a radio access network configuration from the first transport service that indicates a first transport radio bearer and traffic flow information associated with the first transport radio bearer, transmit, to the UE in response to the radio access network configuration, a physical resource configuration for communications associated with the first transport service, and a mapping of the first transport radio bearer to a first channel between the UE and the distributed unit, and communicate, based on the physical resource configuration, the information to be transported via the first transport service between the UE and the first transport service.

Another apparatus for wireless communications at a distributed unit is described. The apparatus may include means for communicating a first service message between a UE and a first transport service offered by a service-based network, the first service message to establish the first transport service and indicating one or more attributes associated with information to be transported via the first transport service, means for receiving a radio access network configuration from the first transport service that indicates a first transport radio bearer and traffic flow information associated with the first transport radio bearer, means for transmitting, to the UE in response to the radio access network configuration, a physical resource configuration for communications associated with the first transport service, and a mapping of the first transport radio bearer to a first channel between the UE and the distributed unit, and means for communicating, based on the physical resource configuration, the information to be transported via the first transport service between the UE and the first transport service.

A non-transitory computer-readable medium storing code for wireless communications at a distributed unit is described. The code may include instructions executable by a processor to communicate a first service message between a UE and a first transport service offered by a service-based network, the first service message to establish the first transport service and indicating one or more attributes associated with information to be transported via the first transport service, receive a radio access network configuration from the first transport service that indicates a first transport radio bearer and traffic flow information associated with the first transport radio bearer, transmit, to the UE in response to the radio access network configuration, a physical resource configuration for communications associated with the first transport service, and a mapping of the first transport radio bearer to a first channel between the UE and the distributed unit, and communicate, based on the physical resource configuration, the information to be transported via the first transport service between the UE and the first transport service.

Some examples of the method, apparatuses, and non-transitory computer-readable medium described herein may further include operations, features, means, or instructions for mapping the first transport radio bearer and at least one other transport radio bearer to the first channel, each transport radio bearer having an associated transport service. In some examples of the method, apparatuses, and non-transitory computer-readable medium described herein, the first service message includes one or more quality of service targets associated with the information to be transported via the first transport service. In some examples of the method, apparatuses, and non-transitory computer-readable medium described herein, the information to be transported via the first transport service may be transmitted using a set of multiple packets, and each packet of the set of multiple packets include an indication of the first transport radio bearer.

In some examples of the method, apparatuses, and non-transitory computer-readable medium described herein, the first transport radio bearer provides communications for both signaling information and data associated with the first transport service. Some examples of the method, apparatuses, and non-transitory computer-readable medium described herein may further include operations, features, means, or instructions for aggregating traffic flow information across the first transport service and one or more other transport services and configuring one or more carriers and one or more resource grants of the physical resource configuration based on aggregated traffic flow information. Some examples of the method, apparatuses, and non-transitory computer-readable medium described herein may further include operations, features, means, or instructions for communicating with the first transport service based on a communication protocol that provides an indication of the first transport radio bearer for each of a set of multiple packets associated with the first transport radio bearer, and that provides an indication of traffic flow information associated with the first transport radio bearer.

### BRIEF DESCRIPTION OF THE DRAWINGS

FIG. 1 illustrates an example of a wireless communications system that supports techniques for data transport in a service-based wireless system in accordance with one or more aspects of the present disclosure.

FIG. 2 illustrates an example of a wireless communications system that supports techniques for data transport in a service-based wireless system in accordance with one or more aspects of the present disclosure.

FIG. 3 illustrates an example of a network architecture that supports techniques for data transport in a service-based wireless system in accordance with one or more aspects of the present disclosure.

FIG. 4 illustrates an example of a transport channel structure that supports techniques for data transport in a service-based wireless system in accordance with one or more aspects of the present disclosure.

FIG. 5 illustrates an example of a process flow that supports techniques for data transport in a service-based wireless system in accordance with one or more aspects of the present disclosure.

FIGS. 6 and 7 show block diagrams of devices that support techniques for data transport in a service-based wireless system in accordance with one or more aspects of the present disclosure.

FIG. 8 shows a block diagram of a communications manager that supports techniques for data transport in a service-based wireless system in accordance with one or more aspects of the present disclosure.

FIG. 9 shows a diagram of a system including a device that supports techniques for data transport in a service-based wireless system in accordance with one or more aspects of the present disclosure.

FIGS. 10 and 11 show block diagrams of devices that support techniques for data transport in a service-based wireless system in accordance with one or more aspects of the present disclosure.

FIG. 12 shows a block diagram of a communications manager that supports techniques for data transport in a service-based wireless system in accordance with one or more aspects of the present disclosure.

FIG. 13 shows a diagram of a system including a device that supports techniques for data transport in a service-based wireless system in accordance with one or more aspects of the present disclosure.

FIGS. 14 through 25 show flowcharts illustrating methods that support techniques for data transport in a service-based wireless system in accordance with one or more aspects of the present disclosure.

### DETAILED DESCRIPTION

Some wireless systems may exhibit a relatively vertical, hierarchical architecture that includes many “layers” of different devices that perform functions for the system. For example, a wireless system may include user equipments (UEs), base stations/network entities, and numerous back-end (e.g. core network) devices associated with one or more functions for the system. Such a hierarchical structure may result in processing and other functions being performed at multiple devices (e.g., duplicative processing or capabilities across multiple back-end devices), thereby leading to wasted resources and excess power consumption. Additionally, the back-end architecture of some wireless systems may be owned and maintained by a small handful of operators, which may make it difficult for other parties/entities to integrate with the systems and may complicate the ability of the systems to offer customized services and functionality to wireless devices.

Comparatively, some wireless systems, such as sixth generation (6G) systems, may exhibit a flatter, service-based architecture in which a radio access network (RAN) (e.g., network entities) interfaces with a service-based network in order to connect UEs to network services maintained at various network addresses within the service-based network. In the context of a service-based system, operations and functions that may otherwise be performed by a few centralized back-end components (e.g., in some systems) may be distributed across a number of network services that may be hosted at different network addresses, such as in a cloud-based architecture. As a result, UEs in a service-based system may be able to establish and maintain connections with (e.g., “subscribe” to) different network services or groups thereof on an a la carte basis, where each network service offers or provides a respective network functionality or service. For example, a service-based system may include a mobility service, a security service, a privacy service, a location service, and the like. In this regard, each UE within a service-based system may be able to select to which network services the UE will subscribe based on the individualized characteristics or needs of the respective UE.

Aspects of the present disclosure relate to signaling and other mechanisms enabling UEs to establish wireless connections in a service-based network. Described techniques relate to signaling between UEs, distributed units (DUs), and a transport service of a service-based network that obtains information related to data to be exchanged in communications with the UE and configures one or more transport channels for such communications. In accordance with various aspects, signaling may be provided between UEs, DUs, and one or more transport services of a service-based cloud network architecture that enable UEs to establish radio bearers (e.g., transport radio bearers), where one or more transport radio bearers are mapped to a logical channel for communications between a UE and DU. For example, a UE may establish a connection with a DU, and receive control signaling indicating a transport service is offered by the network. The UE may transmit (e.g., via the DU) a service request based on data to be transmitted, which may include quality of service (QoS) parameters (e.g., latency, reliability, timing of first packet, etc.). The transport service may communicate with the DU to configure scheduling, resources, and QoS requirements for the transport radio bearer. The DU may determine a radio configuration based on the information received from the transport service, such as physical (PHY) layer parameters (e.g., number of carriers, logical channel mapping to service layer transport radio bearers, uplink/downlink grants, etc.) and layer 2 (L2) parameters (e.g., medium access control (MAC) and radio link control (RLC) parameters, security parameters, packet data convergence protocol (PDCP) parameters, or any combinations thereof). The UE may communicate with the transport service via the DU based on the radio configuration. Dynamic updates may be made based on updated conditions at the UE, network, or both.

Aspects of the disclosure are initially described in the context of wireless communications systems. Additional aspects of the disclosure are described in the context of an example network architecture and an example process flow. Aspects of the disclosure are further illustrated by and described with reference to apparatus diagrams, system diagrams, and flowcharts that relate to techniques for data transport in a service-based wireless system.

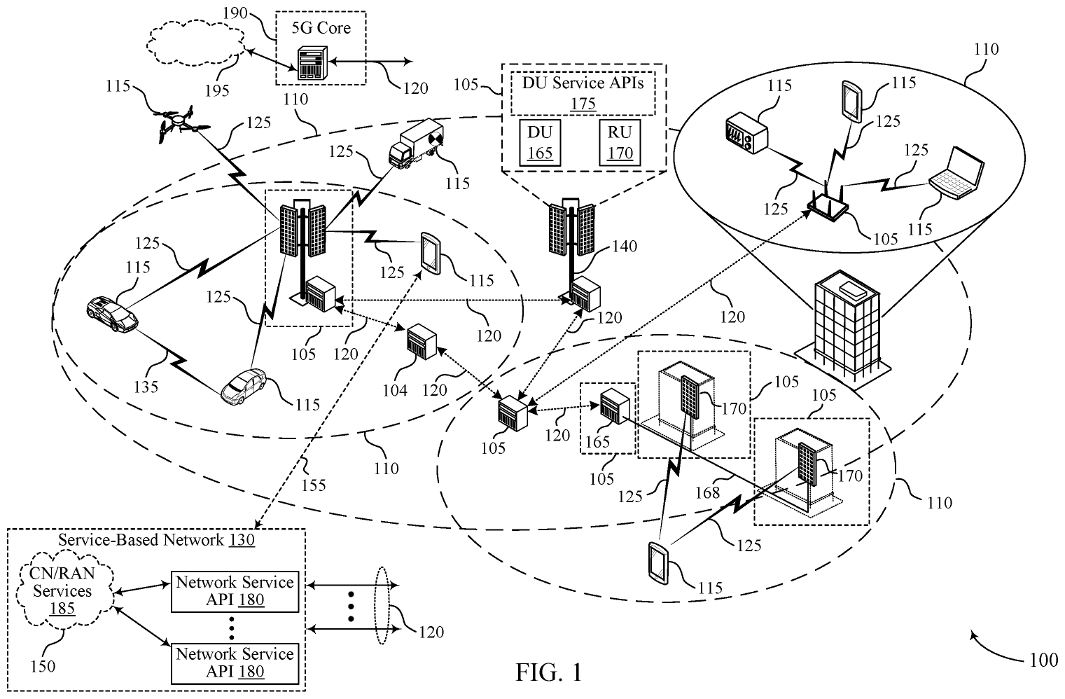

FIG. 1 illustrates an example of a wireless communications system 100 that supports techniques for data transport in a service-based wireless system in accordance with one or more aspects of the present disclosure. The wireless communications system 100 may include one or more network entities 105, one or more UEs 115, and a service-based network 130. In some examples, the wireless communications system 100 may implement aspects of a 6G network, a 5G network (e.g., a New Radio (NR) network), a 4G network (e.g., a Long Term Evolution (LTE) network, an LTE-Advanced (LTE-A) network, an LTE-A Pro network), or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, access point, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the service-based network 130, or with one another, or both. For example, network entities 105 may communicate with the service-based network 130 via one or more backhaul communication links 120 (e.g., in accordance with an S1, N2, N3, or other interface protocol). Similarly, UEs 115 may communicate with the service-based network 130 via one or more communication links 155. In some examples, network entities 105 may communicate with one another via a backhaul communication link 120 (e.g., in accordance with an X2, Xn, or other interface protocol) either directly (e.g., directly between network entities 105) or indirectly (e.g., via a service-based network 130). In some examples, network entities 105 may communicate with one another via one or more communication links such as a fronthaul communication link 168 (e.g., between a radio unit 170 and a distributed unit 165). The backhaul communication links 120 or fronthaul communication links 168, or other communication links between network entities 105, may be or include one or more wired links (e.g., an electrical link, an optical fiber link), one or more wireless links (e.g., a radio link, a wireless optical link), among other examples or various combinations thereof.

In some examples, network entities 105 may communicate with a service platform 150 (e.g., a cloud platform) that provides one or more core network services (CN services), one or more radio access network services (RAN services), or any combinations thereof (CN/RAN services 185). The CN/RAN services 185 may be provided via the service-based network 130, using one or more APIs. For example, one or more DU service APIs 175 may provide an interface for one or more services at a UE 115. The services at the UE 115 may correspond to one or more CN/RAN services 185 at service platform 150. For example, network service APIs 180 at service-based network 130 may interface with corresponding DU service APIs 175 at a DU 165, which interface with corresponding APIs at a UE 115 to provide service connectivity between the one or more UE 115 services and corresponding CN/RAN services 185.

One or more of the network entities 105 described herein may include or may be referred to as a base station 140 (e.g., a base transceiver station, a radio base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, a 6G NB, or other suitable terminology). In some examples, a network entity 105 (e.g., a base station 140) may be implemented in an aggregated (e.g., monolithic, standalone) base station architecture, which may be configured to utilize a service-based architecture and provide radio access within a single network entity 105 (e.g., a single RAN node, such as a base station 140, may include a RU 170, a DU 165, and DU APIs 175 for CN/RAN services 185). An RU 170 may also be referred to as a radio head, a smart radio head, a remote radio head (RRH), a remote radio unit (RRU), or a transmission reception point (TRP).

Additionally, in some examples, one or more network entities 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), a DU 165, RU 170, a RAN Intelligent Controller (MC) (e.g., a Near-Real Time MC (Near-RT MC), a Non-Real Time MC (Non-RT MC)), a Service Management and Orchestration (SMO) system, or any combination thereof. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between components (e.g., CU, DU, and RU) is flexible and may support different functionalities depending on which functions (e.g., network layer functions, protocol layer functions, baseband functions, RF functions, and any combinations thereof) are performed at a component. For example, a functional split of a protocol stack may be employed between a CU and a DU 165 such that the CU may support one or more layers of the protocol stack and the DU 165 may support one or more different layers of the protocol stack. In some examples, the CU may host upper protocol layer (e.g., layer 3 (L3), layer 2 (L2)) functionality and signaling (e.g., RRC, SDAP, PDCP). In some examples, the CU may host one or more service APIs for one or more CN/RAN services 185 via corresponding network service APIs 180 of service-based network 130. The CU may be connected to one or more DUs 165 or RUs 170, and the one or more DUs 165 or RUs 170 may host lower protocol layers, such as layer 1 (L1) (e.g., physical (PHY) layer) or L2 (e.g., RLC layer, MAC layer) functionality and signaling, and may each be at least partially controlled by the CU. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU and a DU 165, or between a DU 165 and an RU 170 may be within a protocol layer (e.g., some functions for a protocol layer may be performed by one of a CU, a DU 165, or an RU 170, while other functions of the protocol layer are performed by a different one of the CU, the DU 165, or the RU 170). A DU 165 may be connected to one or more RUs 170 via a fronthaul communication link 168 (e.g., open fronthaul (FH) interface). In some examples, a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a service-based network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for capability indication to multiple services in a service-based wireless system as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs, RUs 170, RIC, SMO).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., 4G, 5G, 6G radio access technology). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of T_{S}=1/(Δƒₘₐₓ·N_{ƒ}) seconds, for which Δƒₘₐₓ, may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

In some deployments, multiple RANs may be accessed by one or more UEs 115 or network entities 105 such as, for example, a 6G RAT and a 5G RAT. In some examples, the 6G RAT may be associated with service-based network 130 and the 5G RAT may be associated with a 5G Core 190. The 5G core 190 may provide user authentication, access authorization, tracking, Internet Protocol (IP) connectivity, and other access, routing, or mobility functions. The 5G core 190 may be an evolved packet core (EPC), which may include at least one control plane entity that manages access and mobility (e.g., a mobility management entity (MIME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the 5G core 190. User IP packets may be transferred through the user plane entity, which may provide IP address allocation as well as other functions. The user plane entity may be connected to IP services 195 for one or more network operators. The IP services 195 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some examples, the wireless communications system 100 may include a packet-based network that operates using a cloud platform, such as service platform 150, that provides CN/RAN services 185. The CN/RAN services 185, in some examples, may be hosted based on a deployment topology and capabilities for service parameters associated with each service. Providing CN/RAN services 185 allows for separation of particular services (e.g., mobility, connection state management, security, paging, radio access services, quality of service (QoS) configuration and data services, UE capability management, location, messaging, among others) from transport functions (e.g., data radio bearer (DRB) and logical channel (LC) management, data service configuration, among others). Service-based functions (e.g., a message broker decouple radio network procedures from network delivery mechanisms) may allow for flexibility of some functions (e.g., L2 functions) to be hosted anywhere in the cloud, and may enable enhanced scalability, resiliency, elasticity, agility, reuse, visibility, automation, failover, or any combinations thereof (e.g., each service across RAN and core network may scale independently by increasing or decreasing resources allocated across functions independently). Further, efficiency may be enhanced through providing real-time link management to the RAN edge, and allowing for adaptation at the DU 165 for more efficient activation, deactivation, or selection of features based on UE conditions.

In some implementations, the wireless communications system 100 support signaling and other mechanisms that enable UEs 115 to establish wireless connections with the service-based network 130 (e.g., 6G network). In particular, aspects of the present disclosure are directed to signaling between UEs 115, network entities 105 (e.g., DUs 165), and core network services (e.g., CN/RAN services 185) of a service-based network architecture that enable UEs 115 to establish and maintain connections with different network entities 105, different core network services (e.g., CN/RAN services 185) offered by the network, or any combinations thereof, based on capabilities of the UEs that are communicated via a capability service at the service-based network 130. As such, techniques described herein may enable UEs 115 to obtain a capability service context for a capability service, and provide a UE 115 capability indication to the capability service. The capability service may receive the UE 115 capability indication and provide an indication of UE capabilities to one or more other services, to one or more network entities 105, or any combinations thereof. The one or more other services, or one or more network entities 105, may use the indication of UE 115 capabilities to determine various communications parameters.

For example, a UE 115 of the wireless communications system 100 may establish a connection with a DU 165 of a network entity 105, and may receive control signaling indicating a capability service (e.g., as part of CN/RAN services 185) offered by the network. In some cases, the UE 115 may also receive network addresses for offered network services. The UE 115 may then transmit (via relay by the DU 165) a capability service request to a network address of the capability service, and may receive (via relay by the DU 165) a capability service context for communicating with the capability service. The UE 115 may then provide a UE 115 capability indication to the capability service, and the capability service may manage capability information for multiple UEs 115 and provide relevant capabilities to one or more other services or network entities 105. Thus, rather than each service having to separately request an indication of capabilities from a UE 115, the capability service may obtain UE 115 capabilities and provide related information to other services or entities.

In some aspects, UEs 115 may be able to provide capability updates to the capability service. For example, capabilities of a UE 115 may change from an prior UE 115 capability indication (e.g., due to RF emission limits at the UE 115, thermal conditions at the UE 115, a power state at the UE 115, and the like), and an updated capability indication may be provided to the capability service. In some examples, the UE 115 may also provide a time period during which the updated capabilities are value (e.g., a time period at which an RF emission limit will change to allow the UE 115 to transmit using one or more frequency bands associated with the RF emission limit). The capability service may receive the updated capability indication and provide associated UE 115 capabilities to other services or network entities 105 accordingly. In some examples, one or more other services or network entities 105 may provide a subscription request to the capability service, and may be informed of updated capabilities based on updated capability indications that are received at the capability service.

Techniques described herein may enable UEs 115 to efficiently establish and maintain connections with (e.g., subscribe to) core network services offered by a service-based network, such as within a 6G system, based on capabilities of the UEs 115. In particular, techniques described herein may enable UEs 115 to provide capability indications to a capability service, where the capability service may coordinate with other CN/RAN services 185, with other network entities 105, or any combinations thereof, to provide communications using parameters that are in accordance with the UE 115 capabilities. By enabling UEs 115 to provide a capability indication to a capability service, aspects of the present disclosure may enable UEs 115 to establish connections with a wide variety of core network or RAN services that may be offered by different operators or entities without providing separate capability indications for each service. As such, techniques described herein may enable UEs 115 to subscribe to different core network services on an a la carte basis depending on the needs or requirements of the respective UEs 115, thereby improving customization and overall user experience at the UEs 115. Moreover, by enabling UEs 115 to provide capability indications to a capability service, techniques described herein may enable UEs 115 to refrain from communicating with unneeded or unwanted capability indications to multiple different core network services, thereby reducing control signaling within the network, improving resource utilization, and reducing power consumption at the UEs 115.

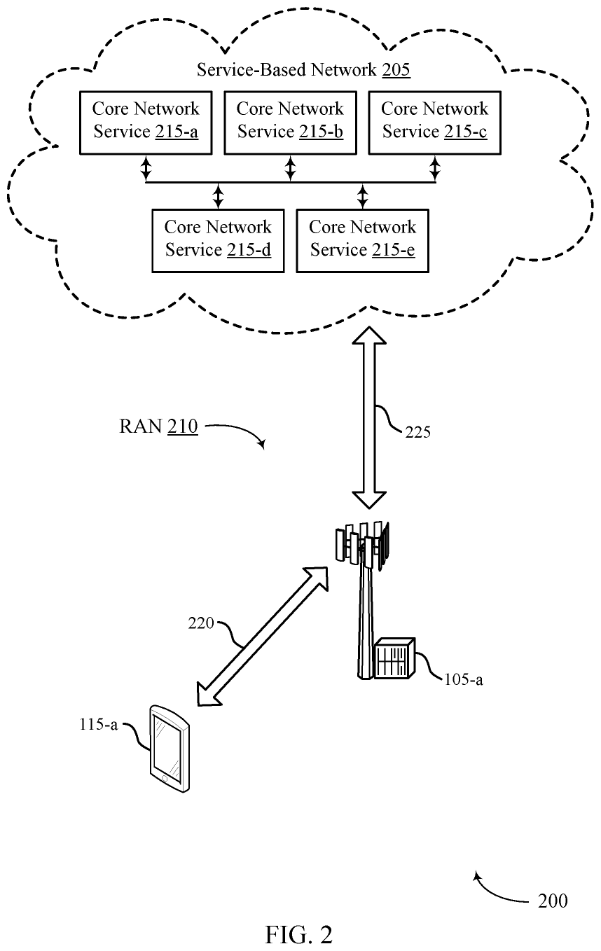

FIG. 2 illustrates an example of a wireless communications system 200 that supports techniques for capability indication to multiple services in a service-based wireless system in accordance with one or more aspects of the present disclosure. Aspects of the wireless communications system 200 may implement, or be implemented by, aspects of the wireless communications system 100. In some implementations, the wireless communications system 200 illustrates an example architecture of a service-based wireless communications system, such as a 6G network as described with reference to FIG. 1.

The wireless communications system 200 may include one or more UEs 115 (e.g., UE 115-a), one or more network entities (e.g., network entity 105-a), and a service-based network 205. In some aspects, the service-based network 205 may be configured to communicate or interface with a RAN 210 of the wireless communications system 200, where the RAN 210 includes the one or more network entities (e.g., network entity 105-a). The service-based network 205 may support or offer a set of core network services 215 (e.g., core network services 215-a, 215-b, 215-c, 215-d, 215-d, 215-e). In some implementations, the service-based network 205 may include or be associated with a cloud platform, where the respective core network services 215 are hosted at respective network addressees in the cloud platform.

The UE 115-a may communicate with the network entity 105-a using one or more communication links 220, which may include an example of an access link (e.g., a Uu link). The communication link 220 may include a bi-directional link that can include both uplink and downlink communication. Similarly, the network entity 105-a of the RAN 210 may be configured to communicate with (e.g., interface with) the service-based network 205 via one or more communication links (e.g., communication link 225), where the communication link 225 may be configured to facilitate bi-directional communications between the network entity 105-a and each of the respective core network services 215 of the service-based network 205.

As shown in FIG. 2, the wireless communications system 200 may exhibit a service-based architecture where the entities of the RAN 210 (e.g., network entity 105-a) are configured to connect the UE 115-a to core network services 215 of the service-based network 205. In particular, the RAN 210 (e.g., network entity 105-a) may be configured to relay communications between the UE 115-a and the various core network services 215 of the service-based network to enable the UE 115-a to establish and maintain wireless connections with the respective core network services 215 in order to exchange communications associated with the various network functionalities that are supported by the respective core network services 215. In other words, the wireless communications system 200 may enable the UE 115-a to “subscribe” to the respective core network services 215 on an a la carte basis depending on the needs or requirements of the UE 115-a. In this regard, different UEs 115 within the wireless communications system 200 may be able to subscribe to different subsets of core network services 215 depending on the capabilities of the UEs 115, applications executed at the UEs 115, a mobility of the UEs 115, etc.

Each core network service 215 may be associated with a respective network address within the service-based network 205. Stated differently, each core network service 215 may be hosted at one or more components of a cloud-based network, where the components of each core network service 215 may be associated with a respective network address. The respective core network services 215 may be provided by network providers, third-party entities, etc., where each core network service 215 is configured to support a respective service or functionality offered to the components of the wireless communications system 200 (e.g., UE 115-a, network entity 105-a).

Different services, functionalities, and core network functions that may be supported or offered by the respective core network services 215 may include, but are not limited to, a capability service, a mobility service, a security service, a privacy service, a location service, etc. For example, the first core network service 215-a may include a core network mobility service that that hosts information and provides signaling that facilitate the geographical movement of the UE 115-a throughout wireless communications system. By way of another example, the second core network service 215-b may include a security service that provides security and encryption services to subscribing UEs 115 within the wireless communications system 200.

In some aspects, each core network service 215 may include a respective API configured to facilitate wireless communications with the network entity 105-a and the UE 115-a, such as the network service APIs 180 illustrated in FIG. 1. APIs at the respective core network services 215 may include routing APIs, configuration APIs, or both. Routing APIs may be configured for service data unit communications between the UE 115-a and the respective core network services 215. Comparatively, configuration APIs may be configured to facilitate communications between the network entity 105-a and the respective core network services 215 to negotiate service requirements and service-specific operation.

In some aspects, the network entity 105-a (e.g., eDU) may facilitate traffic routing (e.g., service data unit routing) from the UE 115-a to the core network services 215, and vice versa. The network entity 105-a may facilitate traffic routing between the respective devices directly, via other network entities 105-a, via proxy, or any combination thereof. Moreover, in some cases, the UE 115-a may be communicatively coupled to multiple network entities 105 (e.g., dual connectivity), where the multiple network entities 105 facilitate traffic routing with the same or different sets of core network services 215. Additionally, the network entity 105-a may support service configurations or service contexts associated with communications parameters within the system, such as QoS flows, security, and UE 115 service contexts. In some aspects, the communication link 220 between the network entity 105-a and the UE 115-a may be associated with an access stratum configuration that facilitates over-the-air service awareness. The access stratum configuration may include logical channels, access stratum security, access stratum context, and the like. For example, the access stratum configuration may be associated with a service-specific configuration (e.g., logical channels corresponding to QoS flows for each respective core network service 215) and a service-agnostic configuration (e.g., parameters which are common to all core network services 215).

The service-based wireless communications system 200 (e.g., 6G network) illustrated in FIG. 2 may exhibit several differences and advantages as compared to some other types of wireless systems, such as networks that instead exhibit a relatively more vertical, hierarchical architecture that includes many “layers” of different devices that perform functions for the network. A more hierarchical structure may result in processing and other functions being performed at multiple devices (e.g., network entity 105 and one or more back-end devices), thereby leading to inefficient use of resources and high power consumption. Additionally, the back-end architecture of a network with a more vertical, hierarchical architecture may be owned and maintained by a small handful of operators, which may render it difficult for other parties/entities to integrate with such systems, and services offered to UEs 115 and other devices may be difficult to customize within such systems.

Comparatively, service-based wireless communications system 200 illustrated in FIG. 2 exhibits a flatter, horizontal architecture which enables the respective functions of wireless communications systems to be distributed across different components (e.g., core network services 215) of the system. For example, such functions and protocols may be divided up and distributed across the set of core network services 215 such that each core network service 215 may support or enable a small portion of the capabilities and functionality of conventional wireless communications systems. In other words, the service-based architecture may enable functions and protocols to be split into self-contained services (e.g., core network services 215) as compared to components that provide all-encompassing network functions and protocols (e.g., modularization of network services/functionality across multiple core network services 215).

In this regard, the wireless communications system 200 may illustrate an example of a cloud-native platform configured to host a merger of CORE and RAN services, which may simplify protocols and reduce a duplication of processing operations across CORE and RAN (e.g., redistribution of CORE and RAN 210 services). In other words, the convergence of RAN 210 and CN functions may reduce repeated operations and functionality to serve one UE at different layers.

The wireless communications system 200 may extend benefits associated with the service-based architecture of the service-based network 205 to the RAN 210, including benefits of increased scalability, resiliency, elasticity, agility, reuse, visibility, automation, and failover. Additionally, the service-based architecture may enable each core network service 215 across RAN 210 and CORE to scale independently by increasing or decreasing resources allocated across the respective core network services 215 independently.

In some implementations, as will be described in further detail herein, the wireless communications system 200 may support signaling that enables the UE 115-a to establish and maintain communications with the core network services 215 of the service-based network 205, such as a 6G network, via transport channels that are configured by a transport service. In particular, aspects of the present disclosure are directed to signaling that enables the UE 115-a to provide QoS metrics (e.g., latency, reliability, timing of first packet, etc.), a buffer status report (BSR), a type of service requested (e.g., best effort with security, high throughput without security, low latency data, etc.), or any combinations thereof, to the transport service (e.g., via the network entity 105-a). The transport service may communicate with the network entity 105-a (e.g., a DU) to configure scheduling, resources, and QoS requirements for the transport radio bearer, and the network entity 105-a may determine a radio configuration based on the information received from the transport service, such as physical (PHY) layer parameters (e.g., number of carriers, logical channel mapping to service layer transport radio bearers, uplink/downlink grants, etc.) and L2 parameters (e.g., MAC and RLC parameters, security parameters, packet data convergence protocol (PDCP) parameters, or any combinations thereof). The UE 115-a may communicate, via the network entity 105-a, based at least in part on the physical resource configuration, the information to be transported via the transport service.

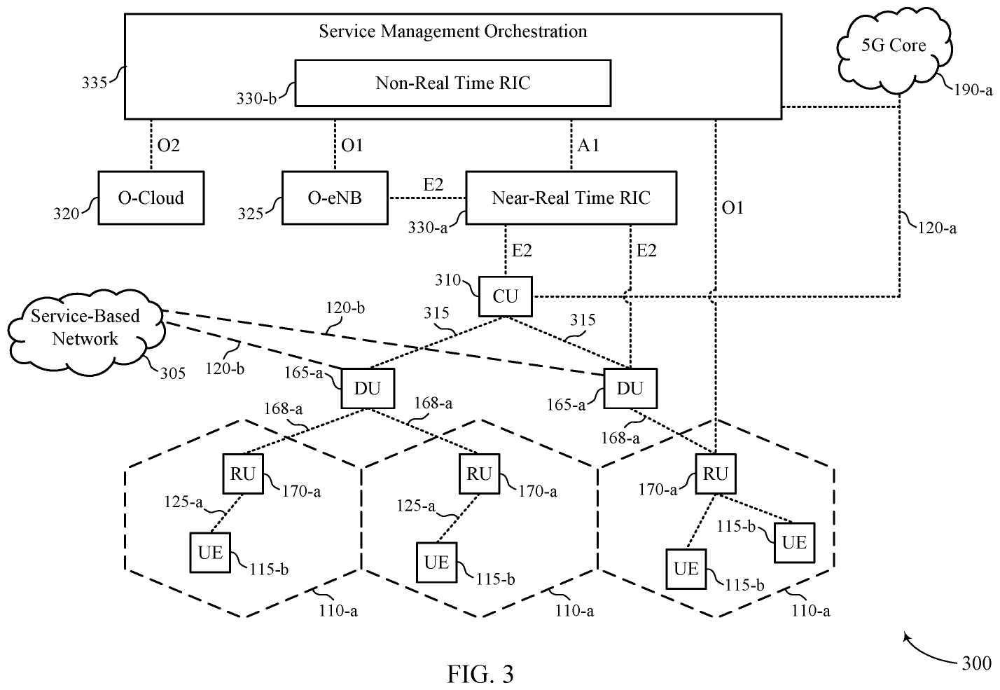

FIG. 3 illustrates an example of a network architecture 300 (e.g., a disaggregated base station architecture, a disaggregated RAN architecture) that supports techniques for capability indication to multiple services in a service-based wireless system in accordance with one or more aspects of the present disclosure. The network architecture 300 may illustrate an example for implementing one or more aspects of the wireless communications system 100. The network architecture 300 may include a service-based network 305, which may be an example of a service-based network 130 or 205, that communicates with DUs 165-a via links 120-b. In this example, DUs 165 may also communicate with one or more CUs 310 that may communicate directly with a 5G core 190-a via a backhaul communication link 120-a, or indirectly with the 5G core 190-a through one or more disaggregated network entities 105 (e.g., a Near-RT RIC 330-a via an E2 link, or a Non-RT RIC 330-b associated with an SMO 335(e.g., an SMO Framework), or both). A CU 310 may communicate with one or more DUs 165-a via respective midhaul communication links 315 (e.g., an F1 interface). The DUs 165-a may communicate with one or more RUs 170-a via respective fronthaul communication links 168-a. The RUs 170-a may be associated with respective coverage areas 110-a and may communicate with UEs 115-b via one or more communication links 125-a. In some implementations, a UE 115-b may be simultaneously served by multiple RUs 170-a.

Each of the network entities 105 of the network architecture 300 (e.g., CUs 310, DUs 165-a, RUs 170-a, Non-RT RICs 330-a, Near-RT RICs 330-b, SMOs 335, Open Clouds (O-Clouds) 320, Open eNBs (O-eNBs) 325) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 310 may host one or more higher layer control functions. Such control functions may include RRC, PDCP, SDAP, or the like. Each control function may be implemented with an interface configured to communicate signals with other control functions hosted by the CU 310. A CU 310 may be configured to handle user plane functionality (e.g., CU-UP), control plane functionality (e.g., CU-CP), or a combination thereof. In some examples, a CU 310 may be logically split into one or more CU-UP units and one or more CU-CP units. A CU-UP unit may communicate bidirectionally with the CU-CP unit via an interface, such as an E1 interface when implemented in an O-RAN configuration. A CU 310 may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, when interfacing with service-based network 305, a DU 165-a may host one or more APIs for one or more services of the service-based network 305 and one or more corresponding services at one or more UEs 115-b. In some examples, when interfacing with CUs 310, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 310.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-b. In some implementations, real-time and non-real-time aspects of control and user plane communication with the RU(s) 170-a may be controlled by the corresponding DU 165-a. In some examples, such a configuration may enable a DU 165-a and a CU 310 to be implemented in a cloud-based RAN architecture, such as a vRAN architecture.

The SMO 335 may be configured to support RAN deployment and provisioning of non-virtualized and virtualized network entities 105. For non-virtualized network entities 105, the SMO 335 may be configured to support the deployment of dedicated physical resources for RAN coverage requirements which may be managed via an operations and maintenance interface (e.g., an O1 interface). For virtualized network entities 105, the SMO 335 may be configured to interact with a cloud computing platform (e.g., an O-Cloud 320) to perform network entity life cycle management (e.g., to instantiate virtualized network entities 105) via a cloud computing platform interface (e.g., an O2 interface). Such virtualized network entities 105 can include, but are not limited to, CUs 310, DUs 165-a, RUs 170-a, and Near-RT RICs 330-a. In some implementations, the SMO 335 may communicate with components configured in accordance with a 4G RAN (e.g., via an O1 interface). Additionally, or alternatively, in some implementations, the SMO 335 may communicate directly with one or more RUs 170-a via an O1 interface. The SMO 335 also may include a Non-RT RIC 330-b configured to support functionality of the SMO 335.

The Non-RT RIC 330-b may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 330-a. The Non-RT RIC 330-b may be coupled to or communicate with (e.g., via an A1 interface) the Near-RT RIC 330-a. The Near-RT RIC 330-a may be configured to include a logical function that enables near-real-time control and optimization of RAN elements and resources via data collection and actions over an interface (e.g., via an E2 interface) connecting one or more CUs 310, one or more DUs 165-a, or both, as well as an O-eNB 325, with the Near-RT MC 330-a.

In some examples, to generate AI/ML models to be deployed in the Near-RT RIC 330-b, the Non-RT RIC 330-b may receive parameters or external enrichment information from external servers. Such information may be utilized by the Near-RT RIC 330-a and may be received at the SMO 335 or the Non-RT RIC 330-b from non-network data sources or from network functions. In some examples, the Non-RT RIC 330-b or the Near-RT RIC 330-a may be configured to tune RAN behavior or performance. For example, the Non-RT RIC 330-b may monitor long-term trends and patterns for performance and employ AI or ML models to perform corrective actions through the SMO 335 (e.g., reconfiguration via O1) or via generation of RAN management policies (e.g., A1 policies).

In some implementations, as will be described in further detail herein, the network architecture 300 may support signaling that enables UEs 115 to establish and maintain communications with core network services of a service-based network, such as a 6G network. In particular, aspects of the present disclosure are directed to signaling between UEs 115, DUs 165, and core network services that enable the UEs 115 to provide transport parameters to a transport service that configures one or more radio bearers that are mapped to one or more logical channels, where two or more radio bearers may be mapped to a single logical channel.

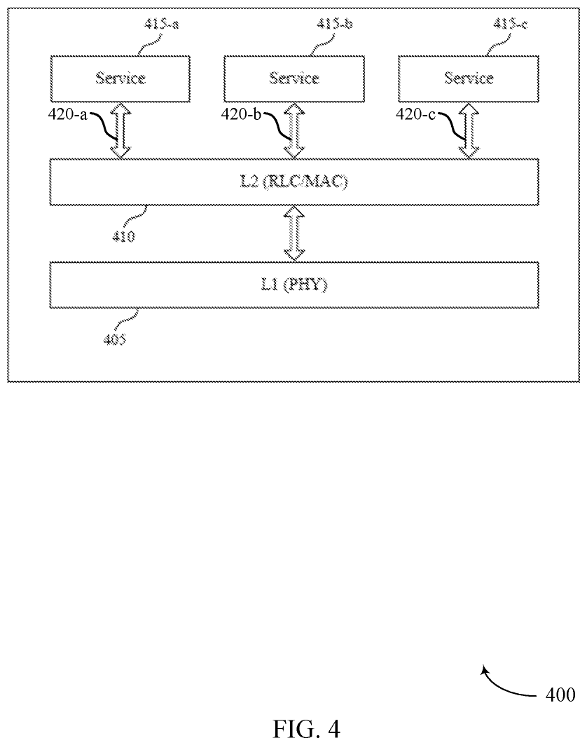

FIG. 4 illustrates an example of a transport channel structure 400 that supports techniques for data transport in a service-based wireless system in accordance with one or more aspects of the present disclosure. The transport channel structure 400 may be implemented by aspects of the wireless communications system 100, the wireless communications system 200, the network architecture 300, or some combination thereof. For example, a UE (e.g., a UE 115 as described with reference to FIGS. 1 through 3) and a network entity (e.g., a network entity 105, such as a DU 165, as described with reference to FIGS. 1 through 3) may implement the channel transport structure 400.

In accordance with various aspects, a transport protocol structure with transport channel structure 400 may enable a cloud-native protocol design for the core network, RAN and UE. In some aspects, a physical layer 405 may provide PHY functions (e.g., RF processing functions, performing FFT, iFFT, digital beamforming, PRACH extraction and filtering, or the like). The physical layer 405 may be coupled with L2 410 that may provide RLC processing, SDAP processing, PDCP processing, MAC processing, or any combinations thereof. As discussed herein, one or more different services 415 may provide higher layer processing (e.g., L3 and higher layer processing, and optionally one or more L2 functions). In the example of FIG. 4, three services 415 are illustrated, including a first service 415-a, a second service 415-b, and a third service 415-c that may each have an associated transport radio bearer 420 (e.g., first transport radio bearer 420-a, second transport radio bearer 420-b, and third transport radio bearer 420-c). While three services 415 and associated transport radio bearer 420 are illustrated in FIG. 4, other examples may have more or fewer services 415.

In accordance with some aspects, one or more transport radio bearers (e.g., which may transport information associated with signaling radio bearers and data radio bearers such as used in 5G networks) may be mapped to a single channel between a UE and network entity (e.g., a logical channel). In some cases, a network entity, such as a DU, may accumulate requests from the different services (e.g., performing functions of a CU and AMF). In some cases, transport radio bearers may be service specific, with QoS targets provided per transport radio bearer 420 per service 415. In some cases, packets that are transported via transport radio bearers 420 may include an indication of an associated service. In some cases, the mapping between transport radio bearers 420 and logical channels may be provided by the transport service. In some cases, such mapping may be one-to-one mapping (e.g., one transport radio bearer 420 to one logical channel), many-to-one mapping (e.g., multiple transport radio bearers 420 to one logical channel, which may be a default mode of operation when no mapping is requested from the transport service), or many-to-many mapping (e.g., multiple transport radio bearers 420 to multiple logical channels, where the multiple transport radio bearers 420 may be associated with a same service or different services, and may be provided across services when public IP or in the same private IP subnet). Thus, each service 415 may split its traffic over multiple channels (e.g., multiple logical channels, such as for signaling information, low priority data, and high priority data, etc.). In some cases, a many-to-many mapping within a service 415 may allow for differentiation of traffic within an application (e.g., voice vs. video, camera position vs. virtual reality streaming, etc.), which may allow a scheduler to identify traffic types based on the channel and schedule accordingly.

As discussed herein, the services 415 may include a transport service, where a transport service API at the UE may initiate a request with an associated transport service at the network to establish a transport radio bearer. In some cases, one or more QoS targets may be provided (e.g., from a UE that transmits the request), and in such cases the transport service may configure a serving DU to enable correct delivery of the service including QoS targets for connection. The transport service may negotiate QoS requirements and manage end-to-end bearers/flows with the UE. In cases where the data transported is for best effort services, the associated bearer or flow can run over an existing IP service (e.g., an IP service that has been previously established). Another service may perform admission control similar to 5G CU-CP functions. In some cases, an API may be used for interfacing between the UE and transport service, which may provide for configuration of traffic flow information (e.g., QoS requirements, butter status report, etc.), and configuration of a traffic pattern (e.g., uplink/downlink traffic pattern). In some cases, an API at the network may expose scheduler loading and constraints, expose discontinuous reception (DRX), configuration options, expose real-time QoS measurements at the UE and network, or any combinations thereof.

A UE operating in such a system may establish a context with one or more transport services in the network (e.g., a context for best effort mobility with security, high throughput without security, low latency data, or the like). The UE may maintain an active transport state when the service is being used and UE is connected to the network device (e.g., DU or other RAN node), such as by sending BSR reports to the transport service. In some cases, the UE may perform throughput throttling for the downlink and uplink directions. In some cases, the UE may request the transport service to throttle the downlink traffic. Additionally, or alternatively, the UE may throttle uplink traffic based on requests from a service 415. In some cases, the UE may determine the transport service has become inactive, such as via data inactivity, an in-band or out-of-band end of data indication, explicit signaling from the service 415, the UE disconnecting from network entity. a local protocol error (e.g., if signaling towards service fails repeatedly), or any combinations thereof.

In some cases, a UE may determine the need to use one or more transport service for which the UE has established a context and are currently inactive. In some cases, a UE may send an activation request to the network entity (e.g., a DU), the activation request containing one or more services to activate, and that may contain routing information and optionally additional service protocol message to be delivered to service, additional information such as initial buffer status deport per transport radio bearer, a deadline to deliver a first packet, or the like. In some cases, the network entity may provide, to the UE, a confirmation in an activation response of which services are activated, and may move the transport service(s) to active if confirmed. In some cases, for each requested service that was not activated, the UE may receive, either in direct local signaling or in one or more service protocol messages, a cause for activation failure (e.g. a cause code). In such an event, the UE may remove the context for the service based on the failure cause, and the UE may attempt to reestablish a context with the service or establish context with another service based on the failure. In some cases, optionally for a UE controlled connection, if the UE determines that no more services are active, or a UE buffer associated with the services is empty (e.g., for a transport service, the UE may have transmitted all the data or the data has expired locally), the UE may send a request to the network entity to release the connection. The request may contain further signaling to one or more services if they are active.

In some cases, the network entity (e.g., a DU), may perform operations associated with transport services. For example, the network entity may establish a connection with the UE, which may include configuring the UE with physical resources (PHY/L2) to support the transport services, dynamically updating that configuration as service requirements change, activating carriers, and providing uplink and downlink grants. In some cases, based on UE request, the network entity may send a request for activation to one or more services, which may provide logical channel mapping to service layer transport radio bearers. The network entity may communicate with the transport service via a communication protocol that provides packet delimitation and other transport services such as flow control. In some cases, the network entity may receive, from the one or more services, a request for maintaining a context for the service. The network entity may receive, at a later stage, an indication from one or more services (or UE) that the service has become inactive, or may determine that the UE has no active services, and release the local connection for the UE based on the determination. If any service was still active, the network entity may indicate to those services the connection is released (e.g., further including service protocol message if provided by the UE).

In some cases, the transport service may perform various actions related to data transport. The transport service may, for example, establish a context with a UE connected to a network entity (e.g., a DU), and determining the UE is active. In some cases, the transport service may be provided at a defined layer (e.g., the IP layer or PDCP layer). The transport service, in some case, may requesting the network entity to maintain an active context for the UE, which may help to provide an expected quality of service per transport radio bearer. In some cases, the transport service also may maintain a context with the network entity (e.g., DU) to which the UE is connected (e.g., how to address, and service related configuration in the network entity, while the service is active), which may include updating requirements with time such as providing dynamically or periodically expected throughput requirements, providing feedback on the quality of service received, or any combinations thereof. In some cases, the transport service may initiate a move to an inactive mode. For example, it may be determined that the service is no longer active (e.g., based on an end-to-end protocol closure/release or lack of transmission for a period of time), and the transport service may notify the network entity that the service is no longer active. In other cases, the network entity may initiate a move to the inactive mode, such as through an indication that the transport service has been deactivated at the network entity (e.g., due to local connection release or failure), or an indication that the transport service is inactive for the UE. When the UE is moved to inactive in the service, in some cases, the transport service may maintain a UE context, or may not maintain up-to-date information associated with the network entity the UE is connected to (e.g., either release the network entity information or keep only a “last connected DU” set of information, in case UE re-connects on same DU).

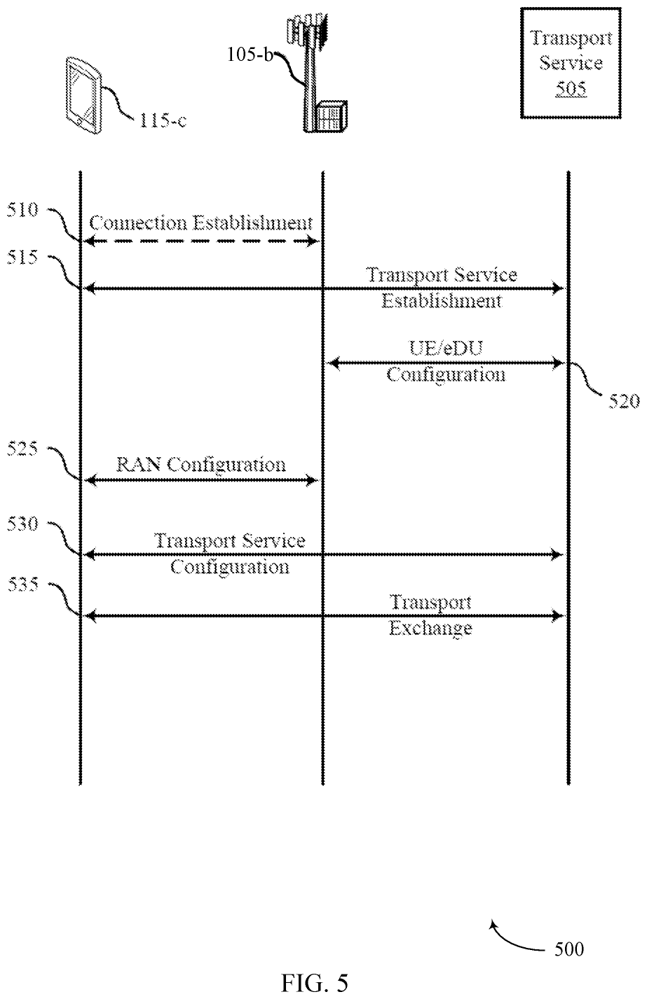

FIG. 5 illustrates an example of a process flow 500 that supports techniques for data transport in a service-based wireless system in accordance with one or more aspects of the present disclosure. The process flow 500 may include a UE 115-c, which may be an example of a UE 115 as described herein, and a network entity 105-b (e.g., a DU 165) as described herein. The process flow 500 may include a transport service 505, which may be an example of a transport service as described herein. In the following description of the process flow 500, the operations between the UE 115-c, the network entity 105-b, and the transport service 505 may be transmitted in a different order than the example order shown, or the operations performed the UE 115-c, the network entity 105-b, and the transport service 505 may be performed in different orders or at different times. Some operations may also be omitted from the process flow 500, and other operations may be added to the process flow 500.

At 510, the UE 115-c and network entity 105-b may perform a connection establishment in accordance with network connection establishment techniques (e.g., an RRC connection establishment procedure). In some cases, as part of a connection establishment, or subsequent to a connection establishment, the UE 115-c may receive control information from the network entity 105-b indicating routing information for a transport service 505 for a set of core network services offered by a service-based network configured to interface with a RAN associated with the network entity 105-b.

At 515, the UE 115-c and network entity 105-b may perform a transport service establishment procedure to establish a context for the transport service 505 and the UE 115-c. For example, the UE 115-c may transmit, to the network entity 105-b, a request that includes the routing information for the transport service 505 (e.g., that may be provided by another network service, such as a discovery service). The network entity 105-b may communicate the request to the transport service 505 based on the routing information. For example, the request may be transmitted to the network entity 105-b for relay to a network address associated with the transport service 505, where the network address is based on the routing information. Based on the request, the transport service 505 may communicate, to the network entity 105-b, a response that may include service context information and logical channel mapping to one or more transport ratio bearers. The network entity 105-b may transmit the service context information to the UE 115-c.

At 520, the transport service 505 may exchange information with the network entity 105-b for transport configuration. For example, the transport service 505 may provide information for one or more transport radio bearers, one or more logical channels, and a mapping of one or more transport radio bearers to the one or more logical channels.

At 525, the network entity 105-b and the UE 115-c may exchange information related to a wireless channel configuration for radio communications (e.g., RAN communications). For example, the network entity 105-b and UE 115-c may communicate parameters for one or more logical channels, and one or more transport radio bearers.

At 530, the UE 115-c and the transport service 505 may communicate a transport service configuration. For example, the transport service configuration may include configuration of traffic flow information (e.g., QoS targets), configuration of traffic patterns, and the like. At 535, the UE 115-c and the transport service 505 may exchange data in accordance with the transport service configuration.

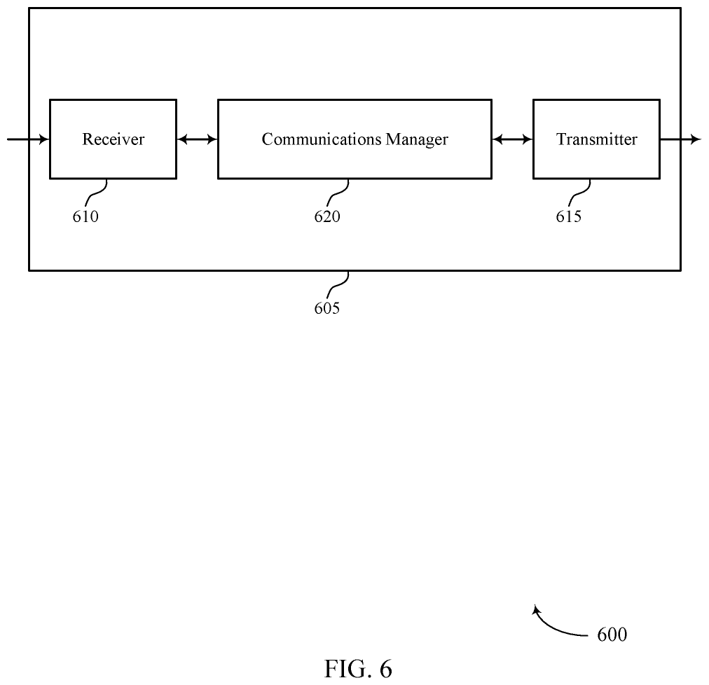

FIG. 6 shows a block diagram 600 of a device 605 that supports techniques for data transport in a service-based wireless system in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for data transport in a service-based wireless system). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for data transport in a service-based wireless system). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of techniques for data transport in a service-based wireless system as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for communicating, via a distributed unit, a first service message to establish a first transport radio bearer with a first transport service offered by a service-based network, the first service message indicating one or more attributes associated with information to be transported via the first transport radio bearer. The communications manager 620 may be configured as or otherwise support a means for receiving, from the distributed unit in response to the first service message, a physical resource configuration for communications associated with the first transport service, and a mapping of the first transport radio bearer to a first channel (e.g., a first logical channel) between the UE and the distributed unit. The communications manager 620 may be configured as or otherwise support a means for communicating, via the distributed unit based on the physical resource configuration, the information to be transported via the first transport service.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, and more efficient utilization of communication resources.

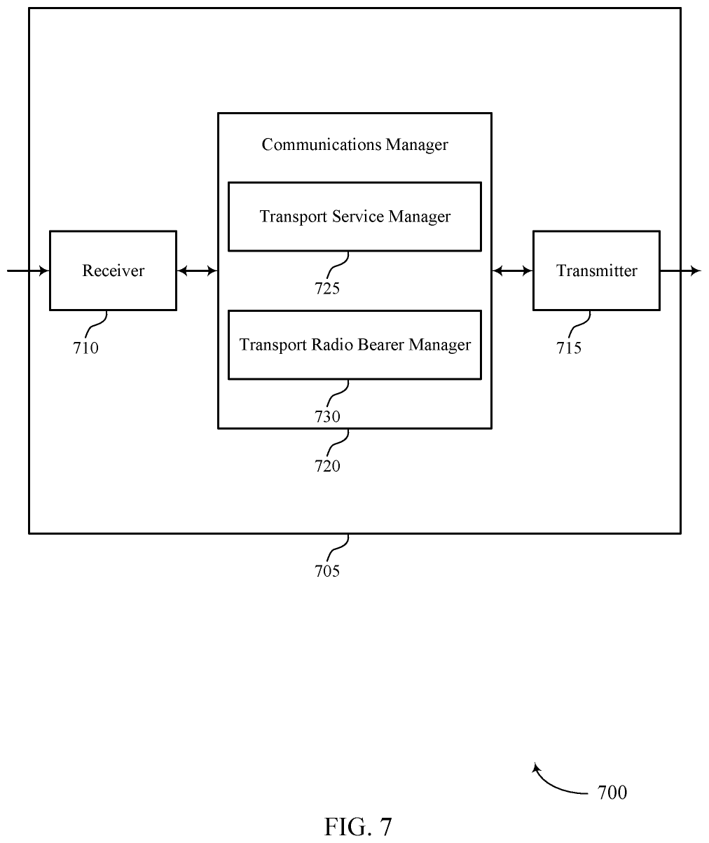

FIG. 7 shows a block diagram 700 of a device 705 that supports techniques for data transport in a service-based wireless system in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for data transport in a service-based wireless system). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for data transport in a service-based wireless system). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for data transport in a service-based wireless system as described herein. For example, the communications manager 720 may include a transport service manager 725 a transport radio bearer manager 730, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The transport service manager 725 may be configured as or otherwise support a means for communicating, via a distributed unit, a first service message to establish a first transport radio bearer with a first transport service offered by a service-based network, the first service message indicating one or more attributes associated with information to be transported via the first transport radio bearer. The transport radio bearer manager 730 may be configured as or otherwise support a means for receiving, from the distributed unit in response to the first service message, a physical resource configuration for communications associated with the first transport service, and a mapping of the first transport radio bearer to a first channel between the UE and the distributed unit. The transport radio bearer manager 730 may be configured as or otherwise support a means for communicating, via the distributed unit based on the physical resource configuration, the information to be transported via the first transport service.

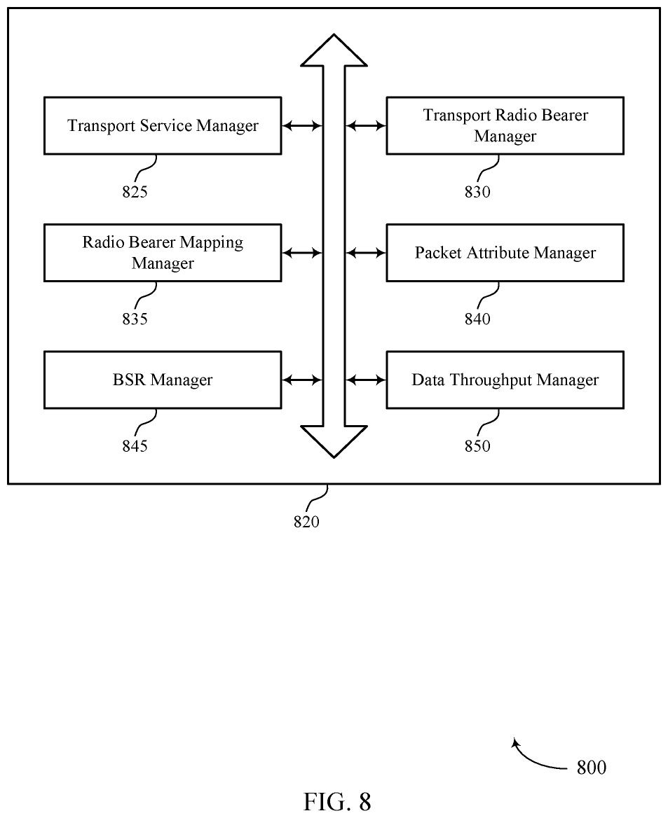

FIG. 8 shows a block diagram 800 of a communications manager 820 that supports techniques for data transport in a service-based wireless system in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for data transport in a service-based wireless system as described herein. For example, the communications manager 820 may include a transport service manager 825, a transport radio bearer manager 830, a radio bearer mapping manager 835, a packet attribute manager 840, an BSR manager 845, a data throughput manager 850, or any combination thereof. Each of these components may communicate, directly or indirectly, with one another (e.g., via one or more buses).

The communications manager 820 may support wireless communications at a UE in accordance with examples as disclosed herein. The transport service manager 825 may be configured as or otherwise support a means for communicating, via a distributed unit, a first service message to establish a first transport radio bearer with a first transport service offered by a service-based network, the first service message indicating one or more attributes associated with information to be transported via the first transport radio bearer. The transport radio bearer manager 830 may be configured as or otherwise support a means for receiving, from the distributed unit in response to the first service message, a physical resource configuration for communications associated with the first transport service, and a mapping of the first transport radio bearer to a first channel between the UE and the distributed unit. In some examples, the transport radio bearer manager 830 may be configured as or otherwise support a means for communicating, via the distributed unit based on the physical resource configuration, the information to be transported via the first transport service.

In some examples, the radio bearer mapping manager 835 may be configured as or otherwise support a means for mapping one or more transport radio bearers to the first logical channel, each of the transport radio bearers having an associated transport service. In some examples, the first service message includes one or more quality of service targets associated with the information to be transported via the first transport service. In some examples, the information to be transported via the first transport service is transmitted using a set of multiple packets, and each packet of the set of multiple packets include an indication of the first transport radio bearer. In some examples, the first transport radio bearer provides communications for both signaling information and data associated with the first transport service.

In some examples, to support communicating the first service message, the packet attribute manager 840 may be configured as or otherwise support a means for communicating the one or more attributes associated with information to be transported via the first transport service as one or more quality of service parameters that include a latency target, a throughput target, a security level, or any combinations thereof.

In some examples, the BSR manager 845 may be configured as or otherwise support a means for communicating, via the distributed unit, one or more buffer status reports to the first transport service to maintain an active state at the first transport service.

In some examples, the data throughput manager 850 may be configured as or otherwise support a means for receiving an indication to throttle information to be transported via the first transport service. In some examples, the data throughput manager 850 may be configured as or otherwise support a means for throttling the information communicated via the first transport service independently of an amount of information communicated via one or more other transport services that are different than the first transport service.

In some examples, the transport service manager 825 may be configured as or otherwise support a means for communicating, via the distributed unit, a second service message that indicates to deactivate the first transport radio bearer associated with the first transport service. In some examples, the transport service manager 825 may be configured as or otherwise support a means for obtaining, subsequent to a deactivation of the first transport service, further information to be transported via the first transport radio bearer. In some examples, the transport service manager 825 may be configured as or otherwise support a means for communicating, via the distributed unit, a third service message to activate the first transport radio bearer. In some examples, the third service message includes an indication of one or more of a buffer status report associated with the first transport radio bearer, a target delivery time for a first packet of data of the further information to be transported via the first transport radio bearer, or any combinations thereof.

In some examples, the transport service manager 825 may be configured as or otherwise support a means for communicating, via the distributed unit, a second service message that indicates to release the first transport radio bearer associated with the first transport service, where the second service message is communicated responsive to a lack of information to be transported via the first transport radio bearer, an expiration of data associated with the first transport radio bearer, or any combinations thereof.

In some examples, the transport radio bearer manager 830 may be configured as or otherwise support a means for receiving, from the distributed unit in response to an updated configuration associated with the first transport service, an updated physical resource configuration. In some examples, the transport radio bearer manager 830 may be configured as or otherwise support a means for communicating, via the distributed unit based on the updated physical resource configuration, the information to be transported via the first transport service.

In some examples, the first transport service is provided at a protocol layer associated with the first transport radio bearer, and where the protocol layer is an Internet protocol (IP) layer or a packet data convergence protocol (PDCP) layer.

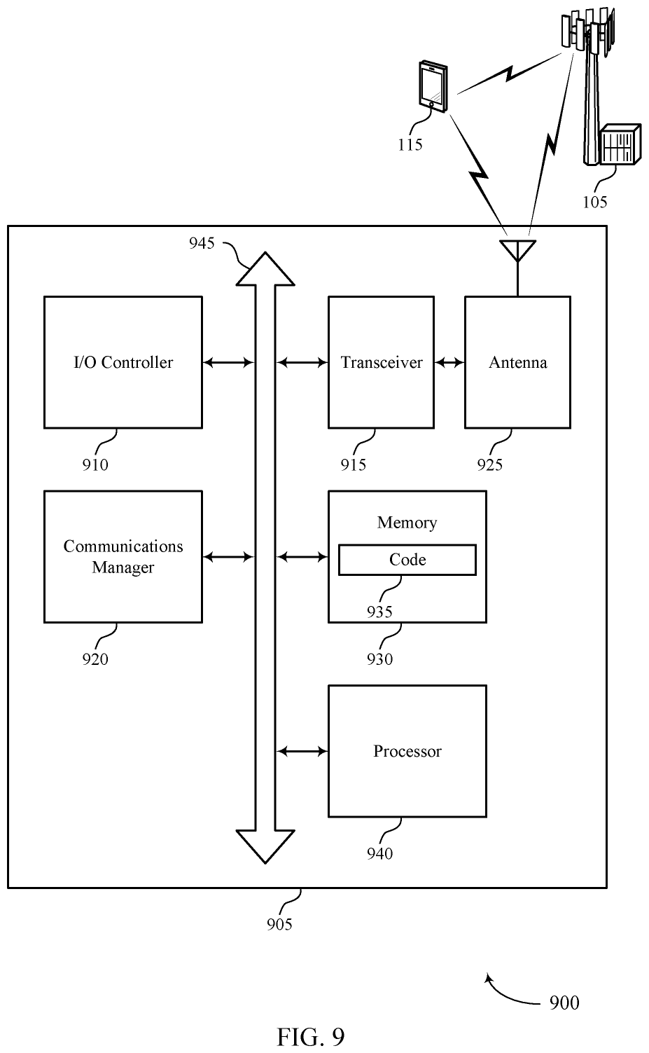

FIG. 9 shows a diagram of a system 900 including a device 905 that supports techniques for data transport in a service-based wireless system in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting techniques for data transport in a service-based wireless system). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for communicating, via a distributed unit, a first service message to establish a first transport radio bearer with a first transport service offered by a service-based network, the first service message indicating one or more attributes associated with information to be transported via the first transport radio bearer. The communications manager 920 may be configured as or otherwise support a means for receiving, from the distributed unit in response to the first service message, a physical resource configuration for communications associated with the first transport service, and a mapping of the first transport radio bearer to a first channel between the UE and the distributed unit. The communications manager 920 may be configured as or otherwise support a means for communicating, via the distributed unit based on the physical resource configuration, the information to be transported via the first transport service.

By including or configuring the communications manager 920 in accordance with examples as described herein, the device 905 may support techniques for reduced processing, reduced power consumption, and more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of techniques for data transport in a service-based wireless system as described herein, or the processor 940 and the memory 930 may be otherwise configured to perform or support such operations.

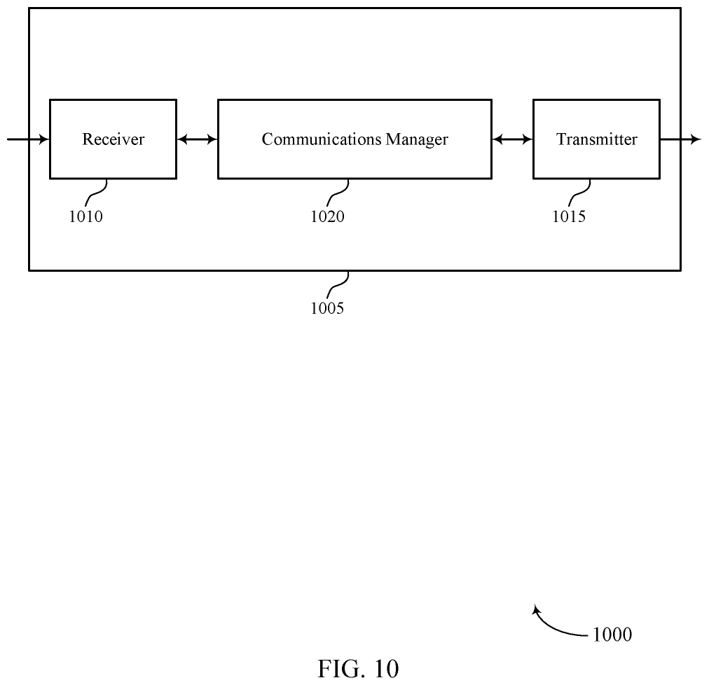

FIG. 10 shows a block diagram 1000 of a device 1005 that supports techniques for data transport in a service-based wireless system in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of techniques for data transport in a service-based wireless system as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a distributed unit in accordance with examples as disclosed herein. For example, the communications manager 1020 may be configured as or otherwise support a means for communicating a first service message between a UE and a first transport service offered by a service-based network, the first service message to establish the first transport service and indicating one or more attributes associated with information to be transported via the first transport service. The communications manager 1020 may be configured as or otherwise support a means for receiving a radio access network configuration from the first transport service that indicates a first transport radio bearer and traffic flow information associated with the first transport radio bearer. The communications manager 1020 may be configured as or otherwise support a means for transmitting, to the UE in response to the radio access network configuration, a physical resource configuration for communications associated with the first transport service, and a mapping of the first transport radio bearer to a first channel between the UE and the distributed unit. The communications manager 1020 may be configured as or otherwise support a means for communicating, based on the physical resource configuration, the information to be transported via the first transport service between the UE and the first transport service.

Additionally, or alternatively, the communications manager 1020 may support wireless communications at a core network service offered by a service-based network in accordance with examples as disclosed herein. For example, the communications manager 1020 may be configured as or otherwise support a means for communicating, via a distributed unit, a first service message with a UE to establish a first transport radio bearer with a first transport service offered by the service-based network, the first service message indicating one or more attributes associated with information to be transported via the first transport radio bearer. The communications manager 1020 may be configured as or otherwise support a means for outputting a second service message to the distributed unit that indicates a radio access network configuration for the first transport radio bearer and traffic flow information associated with the first transport radio bearer. The communications manager 1020 may be configured as or otherwise support a means for communicating, via the distributed unit, the information to be transported via the first transport service using the first transport radio bearer.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, and more efficient utilization of communication resources.

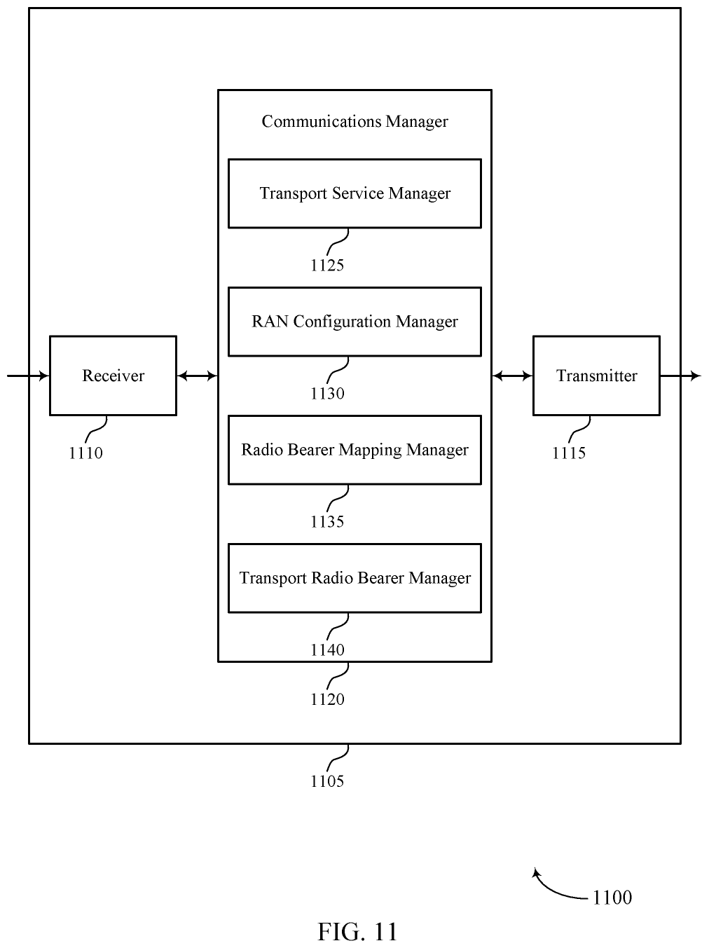

FIG. 11 shows a block diagram 1100 of a device 1105 that supports techniques for data transport in a service-based wireless system in accordance with one or more aspects of the present disclosure. The device 1105 may be an example of aspects of a device 1005 or a network entity 105 as described herein. The device 1105 may include a receiver 1110, a transmitter 1115, and a communications manager 1120.

The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for data transport in a service-based wireless system as described herein. For example, the communications manager 1120 may include a transport service manager 1125, a RAN configuration manager 1130, a radio bearer mapping manager 1135, a transport radio bearer manager 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a distributed unit in accordance with examples as disclosed herein. The transport service manager 1125 may be configured as or otherwise support a means for communicating a first service message between a UE and a first transport service offered by a service-based network, the first service message to establish the first transport service and indicating one or more attributes associated with information to be transported via the first transport service. The RAN configuration manager 1130 may be configured as or otherwise support a means for receiving a radio access network configuration from the first transport service that indicates a first transport radio bearer and traffic flow information associated with the first transport radio bearer. The radio bearer mapping manager 1135 may be configured as or otherwise support a means for transmitting, to the UE in response to the radio access network configuration, a physical resource configuration for communications associated with the first transport service, and a mapping of the first transport radio bearer to a first channel between the UE and the distributed unit. The transport radio bearer manager 1140 may be configured as or otherwise support a means for communicating, based on the physical resource configuration, the information to be transported via the first transport service between the UE and the first transport service.

Additionally, or alternatively, the communications manager 1120 may support wireless communications at a core network service offered by a service-based network in accordance with examples as disclosed herein. The transport service manager 1125 may be configured as or otherwise support a means for communicating, via a distributed unit, a first service message with a UE to establish a first transport radio bearer with a first transport service offered by the service-based network, the first service message indicating one or more attributes associated with information to be transported via the first transport radio bearer. The RAN configuration manager 1130 may be configured as or otherwise support a means for outputting a second service message to the distributed unit that indicates a radio access network configuration for the first transport radio bearer and traffic flow information associated with the first transport radio bearer. The transport radio bearer manager 1140 may be configured as or otherwise support a means for communicating, via the distributed unit, the information to be transported via the first transport service using the first transport radio bearer.

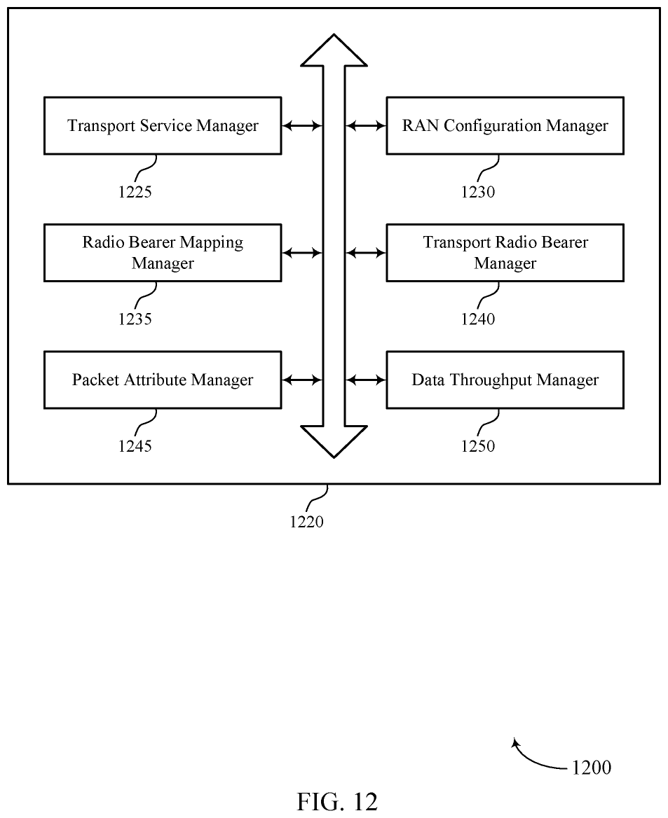

FIG. 12 shows a block diagram 1200 of a communications manager 1220 that supports techniques for data transport in a service-based wireless system in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for data transport in a service-based wireless system as described herein. For example, the communications manager 1220 may include a transport service manager 1225, a RAN configuration manager 1230, a radio bearer mapping manager 1235, a transport radio bearer manager 1240, a packet attribute manager 1245, a data throughput manager 1250, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a distributed unit in accordance with examples as disclosed herein. The transport service manager 1225 may be configured as or otherwise support a means for communicating a first service message between a UE and a first transport service offered by a service-based network, the first service message to establish the first transport service and indicating one or more attributes associated with information to be transported via the first transport service. The RAN configuration manager 1230 may be configured as or otherwise support a means for receiving a radio access network configuration from the first transport service that indicates a first transport radio bearer and traffic flow information associated with the first transport radio bearer. The radio bearer mapping manager 1235 may be configured as or otherwise support a means for transmitting, to the UE in response to the radio access network configuration, a physical resource configuration for communications associated with the first transport service, and a mapping of the first transport radio bearer to a first channel between the UE and the distributed unit. The transport radio bearer manager 1240 may be configured as or otherwise support a means for communicating, based on the physical resource configuration, the information to be transported via the first transport service between the UE and the first transport service.

In some examples, the radio bearer mapping manager 1235 may be configured as or otherwise support a means for mapping the first transport radio bearer and at least one other transport radio bearer to the first logical channel, each transport radio bearer having an associated transport service. In some examples, the first service message includes one or more quality of service targets associated with the information to be transported via the first transport service. In some examples, the information to be transported via the first transport service is transmitted using a set of multiple packets, and each packet of the set of multiple packets include an indication of the first transport radio bearer. In some examples, the first transport radio bearer provides communications for both signaling information and data associated with the first transport service.

In some examples, the RAN configuration manager 1230 may be configured as or otherwise support a means for receiving an updated radio access network configuration from the first transport service that indicates updated traffic flow information associated with the first transport radio bearer. In some examples, the radio bearer mapping manager 1235 may be configured as or otherwise support a means for transmitting, to the UE in response to the updated radio access network configuration, an updated physical resource configuration for communications associated with the first transport service.

In some examples, the data throughput manager 1250 may be configured as or otherwise support a means for aggregating traffic flow information across the first transport service and one or more other transport services. In some examples, the RAN configuration manager 1230 may be configured as or otherwise support a means for configuring one or more carriers and one or more resource grants of the physical resource configuration based on aggregated traffic flow information.

In some examples, the transport service manager 1225 may be configured as or otherwise support a means for communicating with the first transport service based on a communication protocol that provides an indication of the first transport radio bearer for each of a set of multiple packets associated with the first transport radio bearer, and that provides an indication of traffic flow information associated with the first transport radio bearer.

Additionally, or alternatively, the communications manager 1220 may support wireless communications at a core network service offered by a service-based network in accordance with examples as disclosed herein. In some examples, the transport service manager 1225 may be configured as or otherwise support a means for communicating, via a distributed unit, a first service message with a UE to establish a first transport radio bearer with a first transport service offered by the service-based network, the first service message indicating one or more attributes associated with information to be transported via the first transport radio bearer. In some examples, the RAN configuration manager 1230 may be configured as or otherwise support a means for outputting a second service message to the distributed unit that indicates a radio access network configuration for the first transport radio bearer and traffic flow information associated with the first transport radio bearer. In some examples, the transport radio bearer manager 1240 may be configured as or otherwise support a means for communicating, via the distributed unit, the information to be transported via the first transport service using the first transport radio bearer.

In some examples, the first service message includes one or more quality of service targets associated with the information to be transported via the first transport service. In some examples, the information to be transported via the first transport service is transmitted using a set of multiple packets, and each packet of the set of multiple packets include an indication of the first transport radio bearer.

In some examples, the RAN configuration manager 1230 may be configured as or otherwise support a means for providing an updated radio access network configuration to the distributed unit that indicates updated traffic flow information associated with the first transport radio bearer. In some examples, the radio bearer mapping manager 1235 may be configured as or otherwise support a means for communicating with the UE, via the distributed unit, using the first transport radio bearer based on the updated radio access network configuration.

In some examples, the transport service manager 1225 may be configured as or otherwise support a means for communicating with the distributed unit based on a communication protocol that provides an indication of the first transport radio bearer for each of a set of multiple packets associated with the first transport radio bearer, and that provides an indication of traffic flow information associated with the first transport radio bearer.

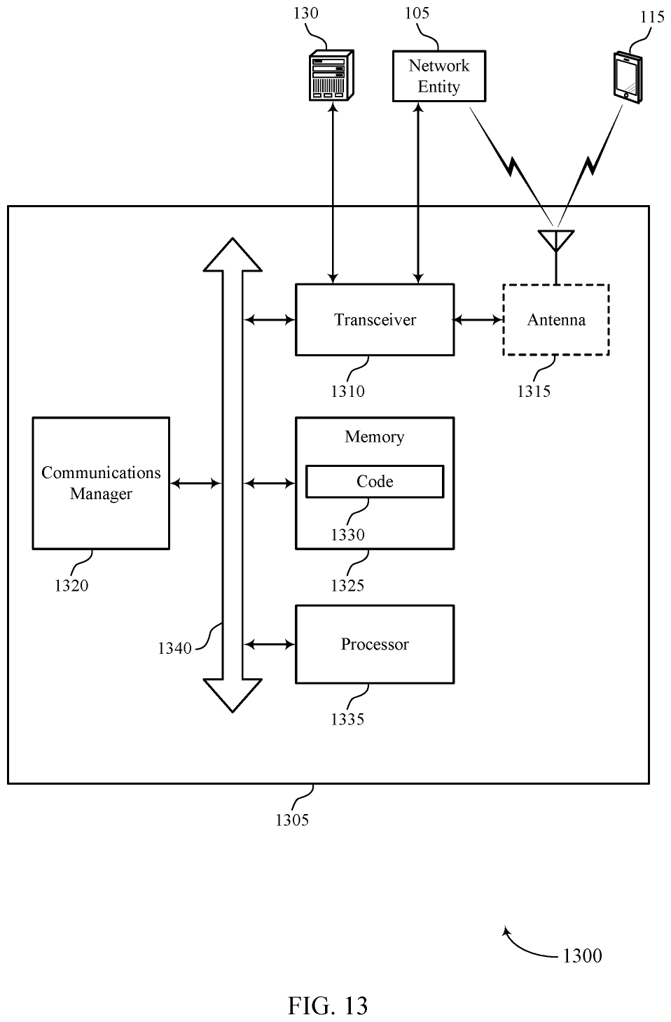

FIG. 13 shows a diagram of a system 1300 including a device 1305 that supports techniques for data transport in a service-based wireless system in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting techniques for data transport in a service-based wireless system). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 1305 may transmit information output from the chip or modem. In some implementations, the second interface may refer to an interface between the processing system of the chip or modem and a receiver, such that the device 1305 may obtain information or signal inputs, and the information may be passed to the processing system. A person having ordinary skill in the art will readily recognize that the first interface also may obtain information or signal inputs, and the second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a distributed unit in accordance with examples as disclosed herein. For example, the communications manager 1320 may be configured as or otherwise support a means for communicating a first service message between a UE and a first transport service offered by a service-based network, the first service message to establish the first transport service and indicating one or more attributes associated with information to be transported via the first transport service. The communications manager 1320 may be configured as or otherwise support a means for receiving a radio access network configuration from the first transport service that indicates a first transport radio bearer and traffic flow information associated with the first transport radio bearer. The communications manager 1320 may be configured as or otherwise support a means for transmitting, to the UE in response to the radio access network configuration, a physical resource configuration for communications associated with the first transport service, and a mapping of the first transport radio bearer to a first channel between the UE and the distributed unit. The communications manager 1320 may be configured as or otherwise support a means for communicating, based on the physical resource configuration, the information to be transported via the first transport service between the UE and the first transport service.

Additionally, or alternatively, the communications manager 1320 may support wireless communications at a core network service offered by a service-based network in accordance with examples as disclosed herein. For example, the communications manager 1320 may be configured as or otherwise support a means for communicating, via a distributed unit, a first service message with a UE to establish a first transport radio bearer with a first transport service offered by the service-based network, the first service message indicating one or more attributes associated with information to be transported via the first transport radio bearer. The communications manager 1320 may be configured as or otherwise support a means for outputting a second service message to the distributed unit that indicates a radio access network configuration for the first transport radio bearer and traffic flow information associated with the first transport radio bearer. The communications manager 1320 may be configured as or otherwise support a means for communicating, via the distributed unit, the information to be transported via the first transport service using the first transport radio bearer.

By including or configuring the communications manager 1320 in accordance with examples as described herein, the device 1305 may support techniques for reduced processing, reduced power consumption, and more efficient utilization of communication resources.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of techniques for data transport in a service-based wireless system as described herein, or the processor 1335 and the memory 1325 may be otherwise configured to perform or support such operations.

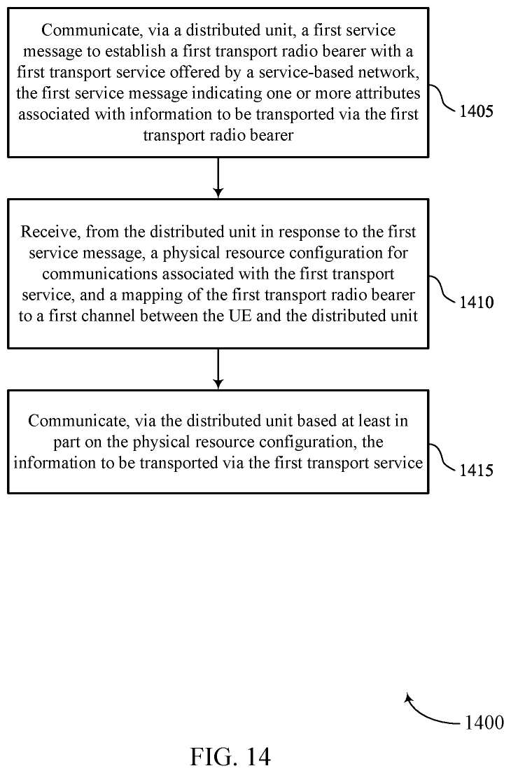

FIG. 14 shows a flowchart illustrating a method 1400 that supports techniques for data transport in a service-based wireless system in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include communicating, via a distributed unit, a first service message to establish a first transport radio bearer with a first transport service offered by a service-based network, the first service message indicating one or more attributes associated with information to be transported via the first transport radio bearer. The operations of 1405 may be performed in accordance with examples as disclosed herein. In some examples, aspects of the operations of 1405 may be performed by a transport service manager 825 as described with reference to FIG. 8.

At 1410, the method may include receiving, from the distributed unit in response to the first service message, a physical resource configuration for communications associated with the first transport service, and a mapping of the first transport radio bearer to a first channel (e.g., a first logical channel) between the UE and the distributed unit. The operations of 1410 may be performed in accordance with examples as disclosed herein. In some examples, aspects of the operations of 1410 may be performed by a transport radio bearer manager 830 as described with reference to FIG. 8.

At 1415, the method may include communicating, via the distributed unit based on the physical resource configuration, the information to be transported via the first transport service. The operations of 1415 may be performed in accordance with examples as disclosed herein. In some examples, aspects of the operations of 1415 may be performed by a transport radio bearer manager 830 as described with reference to FIG. 8.

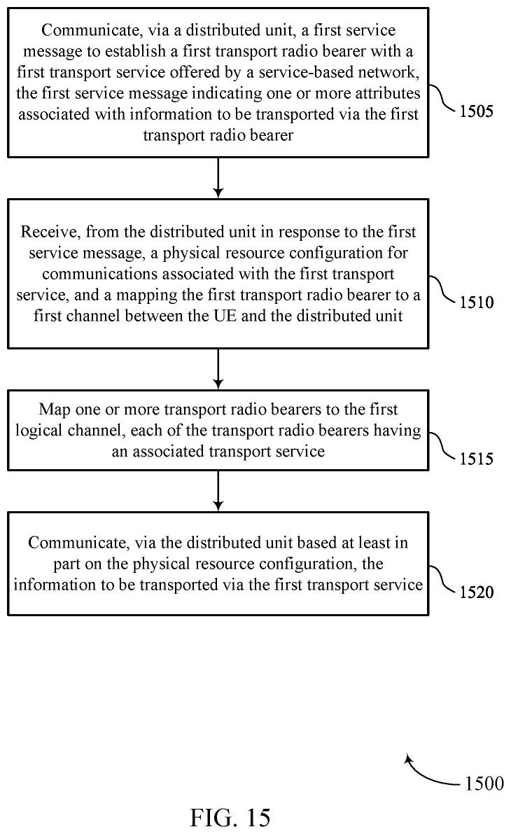

FIG. 15 shows a flowchart illustrating a method 1500 that supports techniques for data transport in a service-based wireless system in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include communicating, via a distributed unit, a first service message to establish a first transport radio bearer with a first transport service offered by a service-based network, the first service message indicating one or more attributes associated with information to be transported via the first transport radio bearer. The operations of 1505 may be performed in accordance with examples as disclosed herein. In some examples, aspects of the operations of 1505 may be performed by a transport service manager 825 as described with reference to FIG. 8.

At 1510, the method may include receiving, from the distributed unit in response to the first service message, a physical resource configuration for communications associated with the first transport service, and a mapping of the first transport radio bearer to a first channel between the UE and the distributed unit. The operations of 1510 may be performed in accordance with examples as disclosed herein. In some examples, aspects of the operations of 1510 may be performed by a transport radio bearer manager 830 as described with reference to FIG. 8.

At 1515, the method may include mapping one or more transport radio bearers to the first logical channel, each of the transport radio bearers having an associated transport service. The operations of 1515 may be performed in accordance with examples as disclosed herein. In some examples, aspects of the operations of 1515 may be performed by a radio bearer mapping manager 835 as described with reference to FIG. 8.

At 1520, the method may include communicating, via the distributed unit based on the physical resource configuration, the information to be transported via the first transport service. The operations of 1520 may be performed in accordance with examples as disclosed herein. In some examples, aspects of the operations of 1520 may be performed by a transport radio bearer manager 830 as described with reference to FIG. 8.

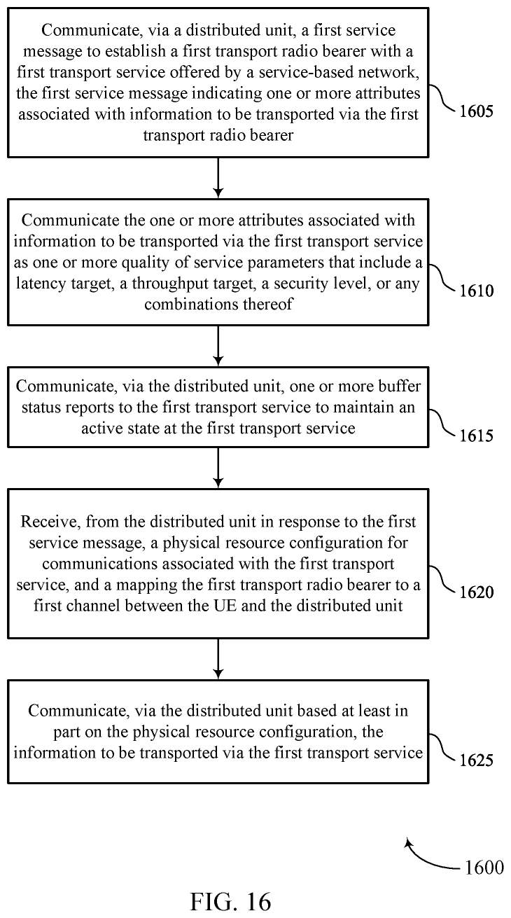

FIG. 16 shows a flowchart illustrating a method 1600 that supports techniques for data transport in a service-based wireless system in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include communicating, via a distributed unit, a first service message to establish a first transport radio bearer with a first transport service offered by a service-based network, the first service message indicating one or more attributes associated with information to be transported via the first transport radio bearer. The operations of 1605 may be performed in accordance with examples as disclosed herein. In some examples, aspects of the operations of 1605 may be performed by a transport service manager 825 as described with reference to FIG. 8.

At 1610, the method may include communicating the one or more attributes associated with information to be transported via the first transport service as one or more quality of service parameters that include a latency target, a throughput target, a security level, or any combinations thereof. The operations of 1610 may be performed in accordance with examples as disclosed herein. In some examples, aspects of the operations of 1610 may be performed by a packet attribute manager 840 as described with reference to FIG. 8.

At 1615, the method may include communicating, via the distributed unit, one or more buffer status reports to the first transport service to maintain an active state at the first transport service. The operations of 1615 may be performed in accordance with examples as disclosed herein. In some examples, aspects of the operations of 1615 may be performed by an BSR manager 845 as described with reference to FIG. 8.

At 1620, the method may include receiving, from the distributed unit in response to the first service message, a physical resource configuration for communications associated with the first transport service, and a mapping the first transport radio bearer to a first channel between the UE and the distributed unit. The operations of 1620 may be performed in accordance with examples as disclosed herein. In some examples, aspects of the operations of 1620 may be performed by a transport radio bearer manager 830 as described with reference to FIG. 8.

At 1625, the method may include communicating, via the distributed unit based on the physical resource configuration, the information to be transported via the first transport service. The operations of 1625 may be performed in accordance with examples as disclosed herein. In some examples, aspects of the operations of 1625 may be performed by a transport radio bearer manager 830 as described with reference to FIG. 8.

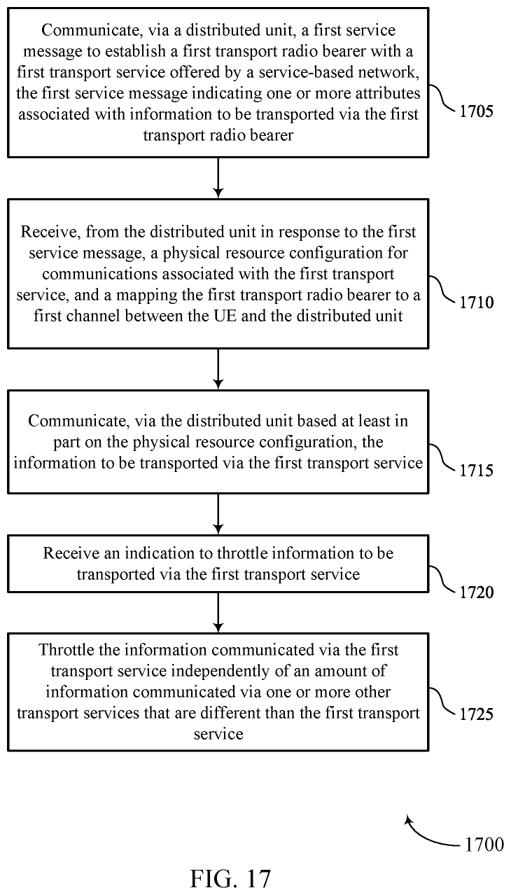

FIG. 17 shows a flowchart illustrating a method 1700 that supports techniques for data transport in a service-based wireless system in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include communicating, via a distributed unit, a first service message to establish a first transport radio bearer with a first transport service offered by a service-based network, the first service message indicating one or more attributes associated with information to be transported via the first transport radio bearer. The operations of 1705 may be performed in accordance with examples as disclosed herein. In some examples, aspects of the operations of 1705 may be performed by a transport service manager 825 as described with reference to FIG. 8.

At 1710, the method may include receiving, from the distributed unit in response to the first service message, a physical resource configuration for communications associated with the first transport service, and a mapping of the first transport radio bearer to a first channel between the UE and the distributed unit. The operations of 1710 may be performed in accordance with examples as disclosed herein. In some examples, aspects of the operations of 1710 may be performed by a transport radio bearer manager 830 as described with reference to FIG. 8.

At 1715, the method may include communicating, via the distributed unit based on the physical resource configuration, the information to be transported via the first transport service. The operations of 1715 may be performed in accordance with examples as disclosed herein. In some examples, aspects of the operations of 1715 may be performed by a transport radio bearer manager 830 as described with reference to FIG. 8.

At 1720, the method may include receiving an indication to throttle information to be transported via the first transport service. The operations of 1720 may be performed in accordance with examples as disclosed herein. In some examples, aspects of the operations of 1720 may be performed by a data throughput manager 850 as described with reference to FIG. 8.

At 1725, the method may include throttling the information communicated via the first transport service independently of an amount of information communicated via one or more other transport services that are different than the first transport service. The operations of 1725 may be performed in accordance with examples as disclosed herein. In some examples, aspects of the operations of 1725 may be performed by a data throughput manager 850 as described with reference to FIG. 8.

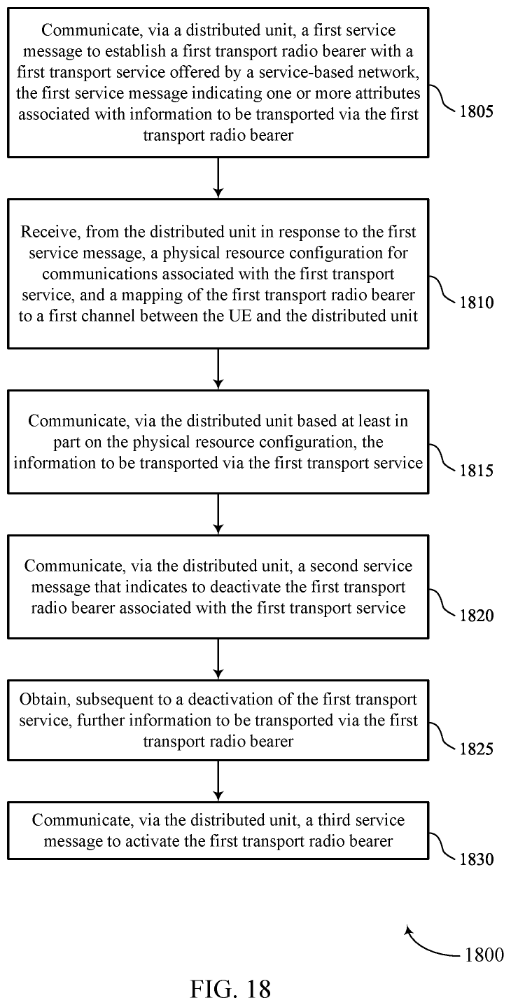

FIG. 18 shows a flowchart illustrating a method 1800 that supports techniques for data transport in a service-based wireless system in accordance with one or more aspects of the present disclosure. The operations of the method 1800 may be implemented by a UE or its components as described herein. For example, the operations of the method 1800 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1805, the method may include communicating, via a distributed unit, a first service message to establish a first transport radio bearer with a first transport service offered by a service-based network, the first service message indicating one or more attributes associated with information to be transported via the first transport radio bearer. The operations of 1805 may be performed in accordance with examples as disclosed herein. In some examples, aspects of the operations of 1805 may be performed by a transport service manager 825 as described with reference to FIG. 8.

At 1810, the method may include receiving, from the distributed unit in response to the first service message, a physical resource configuration for communications associated with the first transport service, and a mapping of the first transport radio bearer to a first channel between the UE and the distributed unit. The operations of 1810 may be performed in accordance with examples as disclosed herein. In some examples, aspects of the operations of 1810 may be performed by a transport radio bearer manager 830 as described with reference to FIG. 8.

At 1815, the method may include communicating, via the distributed unit based on the physical resource configuration, the information to be transported via the first transport service. The operations of 1815 may be performed in accordance with examples as disclosed herein. In some examples, aspects of the operations of 1815 may be performed by a transport radio bearer manager 830 as described with reference to FIG. 8.

At 1820, the method may include communicating, via the distributed unit, a second service message that indicates to deactivate the first transport radio bearer associated with the first transport service. The operations of 1820 may be performed in accordance with examples as disclosed herein. In some examples, aspects of the operations of 1820 may be performed by a transport service manager 825 as described with reference to FIG. 8.

At 1825, the method may include obtaining, subsequent to a deactivation of the first transport service, further information to be transported via the first transport radio bearer. The operations of 1825 may be performed in accordance with examples as disclosed herein. In some examples, aspects of the operations of 1825 may be performed by a transport service manager 825 as described with reference to FIG. 8.

At 1830, the method may include communicating, via the distributed unit, a third service message to activate the first transport radio bearer. The operations of 1830 may be performed in accordance with examples as disclosed herein. In some examples, aspects of the operations of 1830 may be performed by a transport service manager 825 as described with reference to FIG. 8.

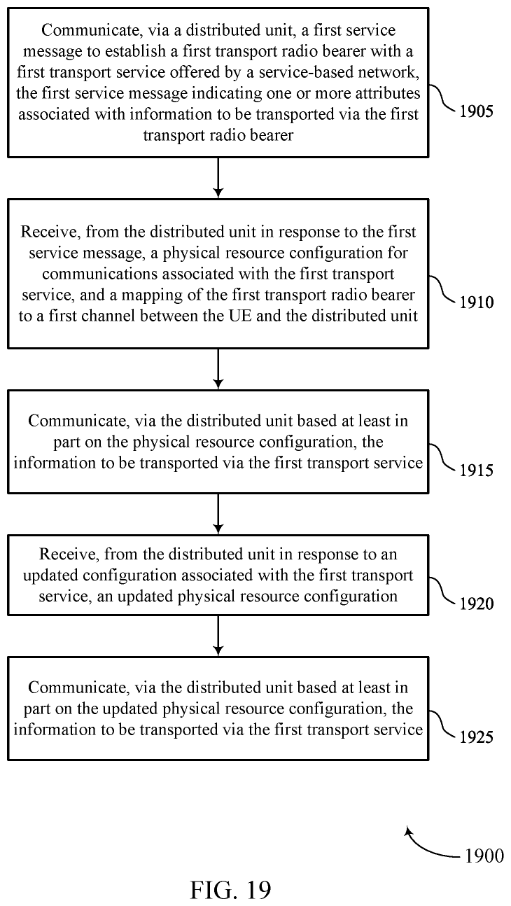

FIG. 19 shows a flowchart illustrating a method 1900 that supports techniques for data transport in a service-based wireless system in accordance with one or more aspects of the present disclosure. The operations of the method 1900 may be implemented by a UE or its components as described herein. For example, the operations of the method 1900 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1905, the method may include communicating, via a distributed unit, a first service message to establish a first transport radio bearer with a first transport service offered by a service-based network, the first service message indicating one or more attributes associated with information to be transported via the first transport radio bearer. The operations of 1905 may be performed in accordance with examples as disclosed herein. In some examples, aspects of the operations of 1905 may be performed by a transport service manager 825 as described with reference to FIG. 8.

At 1910, the method may include receiving, from the distributed unit in response to the first service message, a physical resource configuration for communications associated with the first transport service, and a mapping of the first transport radio bearer to a first channel between the UE and the distributed unit. The operations of 1910 may be performed in accordance with examples as disclosed herein. In some examples, aspects of the operations of 1910 may be performed by a transport radio bearer manager 830 as described with reference to FIG. 8.

At 1915, the method may include communicating, via the distributed unit based on the physical resource configuration, the information to be transported via the first transport service. The operations of 1915 may be performed in accordance with examples as disclosed herein. In some examples, aspects of the operations of 1915 may be performed by a transport radio bearer manager 830 as described with reference to FIG. 8.

At 1920, the method may include receiving, from the distributed unit in response to an updated configuration associated with the first transport service, an updated physical resource configuration. The operations of 1920 may be performed in accordance with examples as disclosed herein. In some examples, aspects of the operations of 1920 may be performed by a transport radio bearer manager 830 as described with reference to FIG. 8.

At 1925, the method may include communicating, via the distributed unit based on the updated physical resource configuration, the information to be transported via the first transport service. The operations of 1925 may be performed in accordance with examples as disclosed herein. In some examples, aspects of the operations of 1925 may be performed by a transport radio bearer manager 830 as described with reference to FIG. 8.

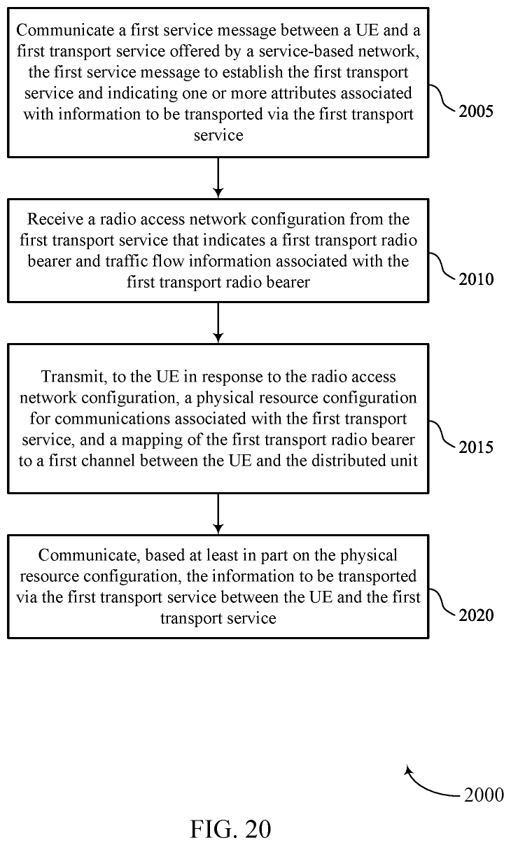

FIG. 20 shows a flowchart illustrating a method 2000 that supports techniques for data transport in a service-based wireless system in accordance with one or more aspects of the present disclosure. The operations of the method 2000 may be implemented by a network entity or its components as described herein. For example, the operations of the method 2000 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2005, the method may include communicating a first service message between a UE and a first transport service offered by a service-based network, the first service message to establish the first transport service and indicating one or more attributes associated with information to be transported via the first transport service. The operations of 2005 may be performed in accordance with examples as disclosed herein. In some examples, aspects of the operations of 2005 may be performed by a transport service manager 1225 as described with reference to FIG. 12.

At 2010, the method may include receiving a radio access network configuration from the first transport service that indicates a first transport radio bearer and traffic flow information associated with the first transport radio bearer. The operations of 2010 may be performed in accordance with examples as disclosed herein. In some examples, aspects of the operations of 2010 may be performed by a RAN configuration manager 1230 as described with reference to FIG. 12.

At 2015, the method may include transmitting, to the UE in response to the radio access network configuration, a physical resource configuration for communications associated with the first transport service, and a mapping of the first transport radio bearer to a first channel between the UE and the distributed unit. The operations of 2015 may be performed in accordance with examples as disclosed herein.

In some examples, aspects of the operations of 2015 may be performed by a radio bearer mapping manager 1235 as described with reference to FIG. 12.

At 2020, the method may include communicating, based on the physical resource configuration, the information to be transported via the first transport service between the UE and the first transport service. The operations of 2020 may be performed in accordance with examples as disclosed herein. In some examples, aspects of the operations of 2020 may be performed by a transport radio bearer manager 1240 as described with reference to FIG. 12.

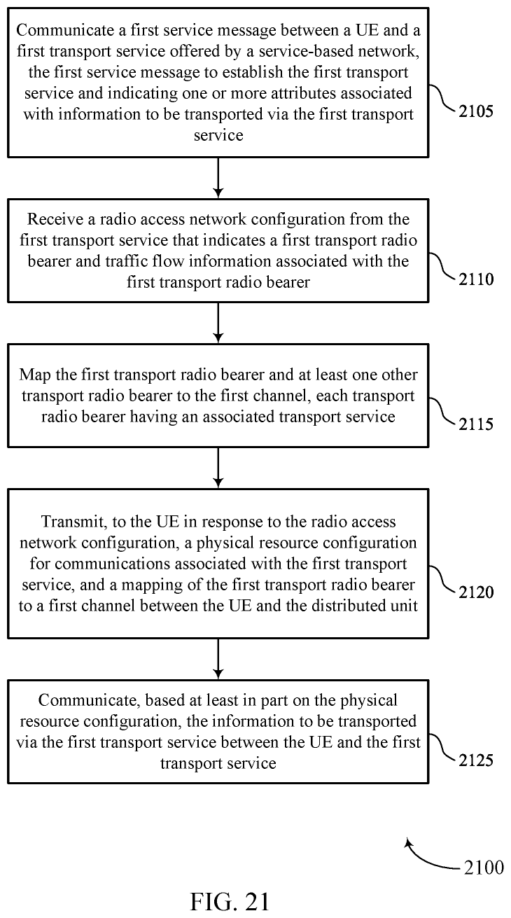

FIG. 21 shows a flowchart illustrating a method 2100 that supports techniques for data transport in a service-based wireless system in accordance with one or more aspects of the present disclosure. The operations of the method 2100 may be implemented by a network entity or its components as described herein. For example, the operations of the method 2100 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2105, the method may include communicating a first service message between a UE and a first transport service offered by a service-based network, the first service message to establish the first transport service and indicating one or more attributes associated with information to be transported via the first transport service. The operations of 2105 may be performed in accordance with examples as disclosed herein. In some examples, aspects of the operations of 2105 may be performed by a transport service manager 1225 as described with reference to FIG. 12.

At 2110, the method may include receiving a radio access network configuration from the first transport service that indicates a first transport radio bearer and traffic flow information associated with the first transport radio bearer. The operations of 2110 may be performed in accordance with examples as disclosed herein. In some examples, aspects of the operations of 2110 may be performed by a RAN configuration manager 1230 as described with reference to FIG. 12.

At 2115, the method may include mapping the first transport radio bearer and at least one other transport radio bearer to the first channel, each transport radio bearer having an associated transport service. The operations of 2115 may be performed in accordance with examples as disclosed herein. In some examples, aspects of the operations of 2115 may be performed by a radio bearer mapping manager 1235 as described with reference to FIG. 12.

At 2120, the method may include transmitting, to the UE in response to the radio access network configuration, a physical resource configuration for communications associated with the first transport service, and a mapping of the first transport radio bearer to a first channel between the UE and the distributed unit. The operations of 2120 may be performed in accordance with examples as disclosed herein. In some examples, aspects of the operations of 2120 may be performed by a radio bearer mapping manager 1235 as described with reference to FIG. 12.

At 2125, the method may include communicating, based on the physical resource configuration, the information to be transported via the first transport service between the UE and the first transport service. The operations of 2125 may be performed in accordance with examples as disclosed herein. In some examples, aspects of the operations of 2125 may be performed by a transport radio bearer manager 1240 as described with reference to FIG. 12.

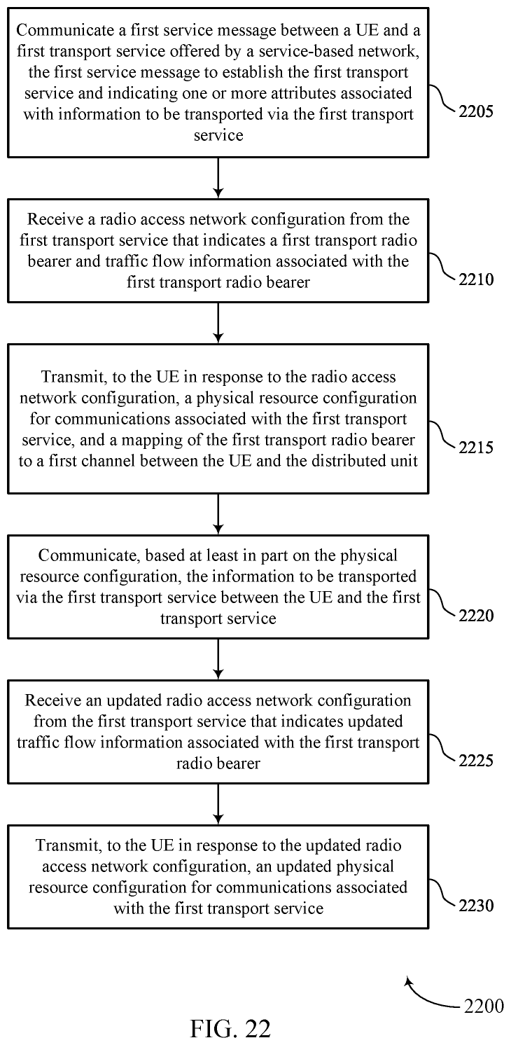

FIG. 22 shows a flowchart illustrating a method 2200 that supports techniques for data transport in a service-based wireless system in accordance with one or more aspects of the present disclosure. The operations of the method 2200 may be implemented by a network entity or its components as described herein. For example, the operations of the method 2200 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2205, the method may include communicating a first service message between a UE and a first transport service offered by a service-based network, the first service message to establish the first transport service and indicating one or more attributes associated with information to be transported via the first transport service. The operations of 2205 may be performed in accordance with examples as disclosed herein. In some examples, aspects of the operations of 2205 may be performed by a transport service manager 1225 as described with reference to FIG. 12.

At 2210, the method may include receiving a radio access network configuration from the first transport service that indicates a first transport radio bearer and traffic flow information associated with the first transport radio bearer. The operations of 2210 may be performed in accordance with examples as disclosed herein. In some examples, aspects of the operations of 2210 may be performed by a RAN configuration manager 1230 as described with reference to FIG. 12.

At 2215, the method may include transmitting, to the UE in response to the radio access network configuration, a physical resource configuration for communications associated with the first transport service, and a mapping of the first transport radio bearer to a first channel between the UE and the distributed unit. The operations of 2215 may be performed in accordance with examples as disclosed herein. In some examples, aspects of the operations of 2215 may be performed by a radio bearer mapping manager 1235 as described with reference to FIG. 12.

At 2220, the method may include communicating, based on the physical resource configuration, the information to be transported via the first transport service between the UE and the first transport service. The operations of 2220 may be performed in accordance with examples as disclosed herein. In some examples, aspects of the operations of 2220 may be performed by a transport radio bearer manager 1240 as described with reference to FIG. 12.

At 2225, the method may include receiving an updated radio access network configuration from the first transport service that indicates updated traffic flow information associated with the first transport radio bearer. The operations of 2225 may be performed in accordance with examples as disclosed herein. In some examples, aspects of the operations of 2225 may be performed by a RAN configuration manager 1230 as described with reference to FIG. 12.

At 2230, the method may include transmitting, to the UE in response to the updated radio access network configuration, an updated physical resource configuration for communications associated with the first transport service. The operations of 2230 may be performed in accordance with examples as disclosed herein. In some examples, aspects of the operations of 2230 may be performed by a radio bearer mapping manager 1235 as described with reference to FIG. 12.

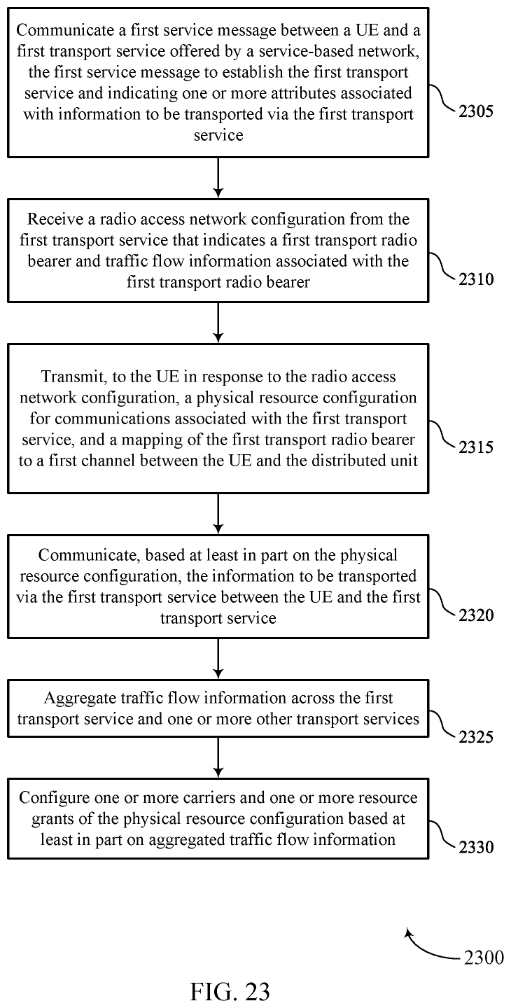

FIG. 23 shows a flowchart illustrating a method 2300 that supports techniques for data transport in a service-based wireless system in accordance with one or more aspects of the present disclosure. The operations of the method 2300 may be implemented by a network entity or its components as described herein. For example, the operations of the method 2300 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2305, the method may include communicating a first service message between a UE and a first transport service offered by a service-based network, the first service message to establish the first transport service and indicating one or more attributes associated with information to be transported via the first transport service. The operations of 2305 may be performed in accordance with examples as disclosed herein. In some examples, aspects of the operations of 2305 may be performed by a transport service manager 1225 as described with reference to FIG. 12.

At 2310, the method may include receiving a radio access network configuration from the first transport service that indicates a first transport radio bearer and traffic flow information associated with the first transport radio bearer. The operations of 2310 may be performed in accordance with examples as disclosed herein. In some examples, aspects of the operations of 2310 may be performed by a RAN configuration manager 1230 as described with reference to FIG. 12.

At 2315, the method may include transmitting, to the UE in response to the radio access network configuration, a physical resource configuration for communications associated with the first transport service, and a mapping of the first transport radio bearer to a first channel between the UE and the distributed unit. The operations of 2315 may be performed in accordance with examples as disclosed herein.

In some examples, aspects of the operations of 2315 may be performed by a radio bearer mapping manager 1235 as described with reference to FIG. 12.

At 2320, the method may include communicating, based on the physical resource configuration, the information to be transported via the first transport service between the UE and the first transport service. The operations of 2320 may be performed in accordance with examples as disclosed herein. In some examples, aspects of the operations of 2320 may be performed by a transport radio bearer manager 1240 as described with reference to FIG. 12.

At 2325, the method may include aggregating traffic flow information across the first transport service and one or more other transport services. The operations of 2325 may be performed in accordance with examples as disclosed herein. In some examples, aspects of the operations of 2325 may be performed by a data throughput manager 1250 as described with reference to FIG. 12.

At 2330, the method may include configuring one or more carriers and one or more resource grants of the physical resource configuration based on aggregated traffic flow information. The operations of 2330 may be performed in accordance with examples as disclosed herein. In some examples, aspects of the operations of 2330 may be performed by a RAN configuration manager 1230 as described with reference to FIG. 12.

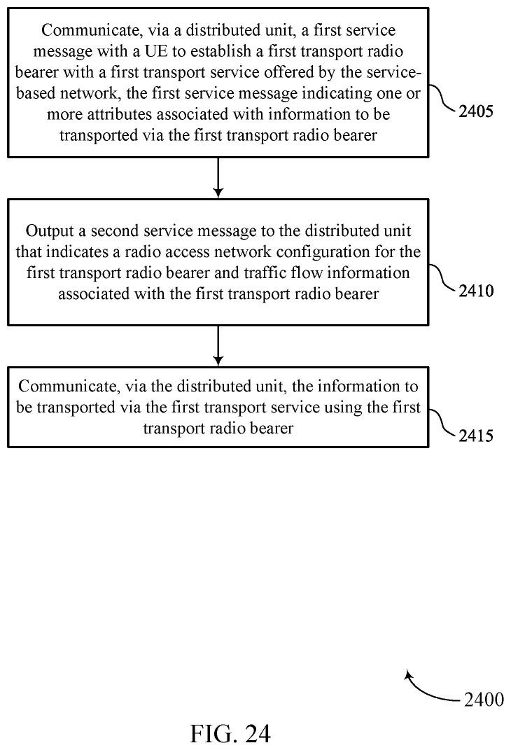

FIG. 24 shows a flowchart illustrating a method 2400 that supports techniques for data transport in a service-based wireless system in accordance with one or more aspects of the present disclosure. The operations of the method 2400 may be implemented by a network entity or its components as described herein. For example, the operations of the method 2400 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2405, the method may include communicating, via a distributed unit, a first service message with a UE to establish a first transport radio bearer with a first transport service offered by the service-based network, the first service message indicating one or more attributes associated with information to be transported via the first transport radio bearer. The operations of 2405 may be performed in accordance with examples as disclosed herein. In some examples, aspects of the operations of 2405 may be performed by a transport service manager 1225 as described with reference to FIG. 12.

At 2410, the method may include outputting a second service message to the distributed unit that indicates a radio access network configuration for the first transport radio bearer and traffic flow information associated with the first transport radio bearer. The operations of 2410 may be performed in accordance with examples as disclosed herein. In some examples, aspects of the operations of 2410 may be performed by a RAN configuration manager 1230 as described with reference to FIG. 12.

At 2415, the method may include communicating, via the distributed unit, the information to be transported via the first transport service using the first transport radio bearer. The operations of 2415 may be performed in accordance with examples as disclosed herein. In some examples, aspects of the operations of 2415 may be performed by a transport radio bearer manager 1240 as described with reference to FIG. 12.

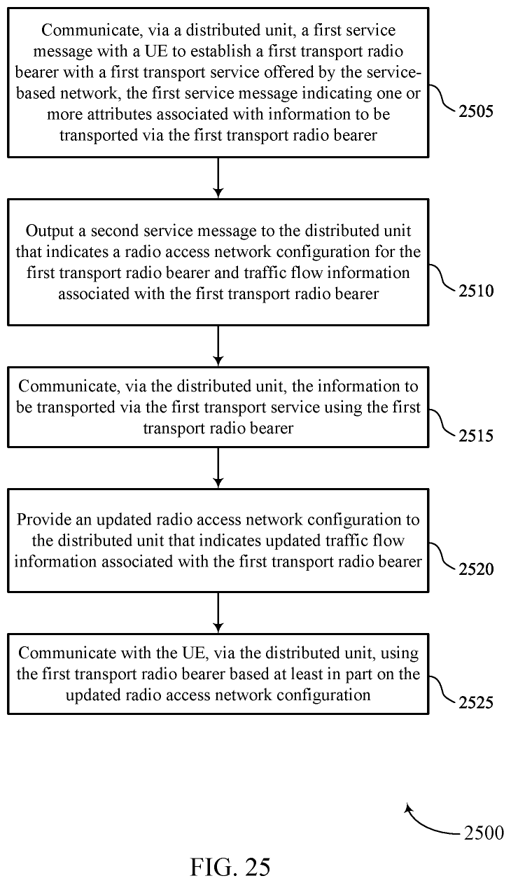

FIG. 25 shows a flowchart illustrating a method 2500 that supports techniques for data transport in a service-based wireless system in accordance with one or more aspects of the present disclosure. The operations of the method 2500 may be implemented by a network entity or its components as described herein. For example, the operations of the method 2500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 2505, the method may include communicating, via a distributed unit, a first service message with a UE to establish a first transport radio bearer with a first transport service offered by the service-based network, the first service message indicating one or more attributes associated with information to be transported via the first transport radio bearer. The operations of 2505 may be performed in accordance with examples as disclosed herein. In some examples, aspects of the operations of 2505 may be performed by a transport service manager 1225 as described with reference to FIG. 12.

At 2510, the method may include outputting a second service message to the distributed unit that indicates a radio access network configuration for the first transport radio bearer and traffic flow information associated with the first transport radio bearer. The operations of 2510 may be performed in accordance with examples as disclosed herein. In some examples, aspects of the operations of 2510 may be performed by a RAN configuration manager 1230 as described with reference to FIG. 12.

At 2515, the method may include communicating, via the distributed unit, the information to be transported via the first transport service using the first transport radio bearer. The operations of 2515 may be performed in accordance with examples as disclosed herein. In some examples, aspects of the operations of 2515 may be performed by a transport radio bearer manager 1240 as described with reference to FIG. 12.

At 2520, the method may include providing an updated radio access network configuration to the distributed unit that indicates updated traffic flow information associated with the first transport radio bearer. The operations of 2520 may be performed in accordance with examples as disclosed herein. In some examples, aspects of the operations of 2520 may be performed by a RAN configuration manager 1230 as described with reference to FIG. 12.

At 2525, the method may include communicating with the UE, via the distributed unit, using the first transport radio bearer based on the updated radio access network configuration. The operations of 2525 may be performed in accordance with examples as disclosed herein. In some examples, aspects of the operations of 2525 may be performed by a radio bearer mapping manager 1235 as described with reference to FIG. 12.

The following provides an overview of aspects of the present disclosure:

Aspect 1: A method for wireless communications at a UE, comprising: communicating, via a distributed unit, a first service message to establish a first transport radio bearer with a first transport service offered by a service-based network, the first service message indicating one or more attributes associated with information to be transported via the first transport radio bearer; receiving, from the distributed unit in response to the first service message, a physical resource configuration for communications associated with the first transport service, and a mapping of the first transport radio bearer to a first channel between the UE and the distributed unit; and communicating, via the distributed unit based at least in part on the physical resource configuration, the information to be transported via the first transport service.

Aspect 2: The method of aspect 1, further comprising: mapping one or more transport radio bearers to the first channel, each of the transport radio bearers having an associated transport service.

Aspect 3: The method of any of aspects 1 through 2, wherein the information to be transported via the first transport service is split over two or more channels between the UE and the distributed unit, including a separate channels for signaling information.

Aspect 4: The method of aspect 3, wherein the split over the two or more channels is based at least in part on one or more of a traffic priority of the information to be transported via the first transport service, a traffic delay tolerance of the information to be transported via the first transport service, a traffic acceptable error rate of the information to be transported via the first transport service, or any combinations thereof.

Aspect 5: The method of any of aspects 1 through 4, wherein two or more transport radio bearers from the first transport service are mapped to the first channel, one transport radio bearer is mapped to the first channel, or multiple transport radio bearers are mapped to each of two or more channels.

Aspect 6: The method of any of aspects 1 through 5, wherein the first service message includes one or more quality of service targets associated with the information to be transported via the first transport service, and different quality of service targets are associated with different channels between the UE and the distributed unit.

Aspect 7: The method of any of aspects 1 through 6, wherein the information to be transported via the first transport service is transmitted using a plurality of packets, and each packet of the plurality of packets include an indication of the first transport radio bearer.

Aspect 8: The method of any of aspects 1 through 7, wherein the first transport radio bearer provides communications for both signaling information and data associated with the first transport service.

Aspect 9: The method of any of aspects 1 through 8, wherein the communicating the first service message comprises: communicating the one or more attributes associated with information to be transported via the first transport service as one or more quality of service parameters that include a latency target, a throughput target, a security level, or any combinations thereof.

Aspect 10: The method of any of aspects 1 through 9, further comprising: communicating, via the distributed unit, one or more buffer status reports to the first transport service to maintain an active state at the first transport service.

Aspect 11: The method of any of aspects 1 through 10, further comprising: receiving an indication to throttle information to be transported via the first transport service; and throttling the information communicated via the first transport service independently of an amount of information communicated via one or more other transport services that are different than the first transport service.

Aspect 12: The method of any of aspects 1 through 11, further comprising: communicating, via the distributed unit, a second service message that indicates to deactivate the first transport radio bearer associated with the first transport service.

Aspect 13: The method of aspect 12, further comprising: obtaining, subsequent to a deactivation of the first transport service, further information to be transported via the first transport radio bearer; and communicating, via the distributed unit, a third service message to activate the first transport radio bearer.

Aspect 14: The method of aspect 13, wherein the third service message includes an indication of one or more of a buffer status report associated with the first transport radio bearer, a target delivery time for a first packet of data of the further information to be transported via the first transport radio bearer, or any combinations thereof.

Aspect 15: The method of any of aspects 1 through 14, further comprising: communicating, via the distributed unit, a second service message that indicates to release the first transport radio bearer associated with the first transport service, wherein the second service message is communicated responsive to a lack of information to be transported via the first transport radio bearer, an expiration of data associated with the first transport radio bearer, or any combinations thereof.

Aspect 16: The method of any of aspects 1 through 15, further comprising: receiving, from the distributed unit in response to an updated configuration associated with the first transport service, an updated physical resource configuration; and communicating, via the distributed unit based at least in part on the updated physical resource configuration, the information to be transported via the first transport service.

Aspect 17: The method of any of aspects 1 through 16, wherein the first transport service is provided at a protocol layer associated with the first transport radio bearer, and the protocol layer is an Internet protocol (IP) layer or a packet data convergence protocol (PDCP) layer.

Aspect 18: A method for wireless communications at a distributed unit, comprising: communicating a first service message between a UE and a first transport service offered by a service-based network, the first service message to establish the first transport service and indicating one or more attributes associated with information to be transported via the first transport service; receiving a radio access network configuration from the first transport service that indicates a first transport radio bearer and traffic flow information associated with the first transport radio bearer; transmitting, to the UE in response to the radio access network configuration, a physical resource configuration for communications associated with the first transport service, and a mapping of the first transport radio bearer to a first channel between the UE and the distributed unit; and communicating, based at least in part on the physical resource configuration, the information to be transported via the first transport service between the UE and the first transport service.

Aspect 19: The method of aspect 18, further comprising: mapping the first transport radio bearer and at least one other transport radio bearer to the first channel, each transport radio bearer having an associated transport service.

Aspect 20: The method of any of aspects 18 through 19, wherein the first service message includes one or more quality of service targets associated with the information to be transported via the first transport service.

Aspect 21: The method of any of aspects 18 through 20, wherein the information to be transported via the first transport service is transmitted using a plurality of packets, and each packet of the plurality of packets include an indication of the first transport radio bearer.

Aspect 22: The method of any of aspects 18 through 21, wherein the first transport radio bearer provides communications for both signaling information and data associated with the first transport service.

Aspect 23: The method of any of aspects 18 through 22, further comprising: aggregating traffic flow information across the first transport service and one or more other transport services; and configuring one or more carriers and one or more resource grants of the physical resource configuration based at least in part on aggregated traffic flow information.

Aspect 24: The method of any of aspects 18 through 23, further comprising: communicating with the first transport service based at least in part on a communication protocol that provides an indication of the first transport radio bearer for each of a plurality of packets associated with the first transport radio bearer, and that provides an indication of traffic flow information associated with the first transport radio bearer.

Aspect 25: An apparatus for wireless communications at a UE, comprising a processor; memory coupled with the processor; and instructions stored in the memory and executable by the processor to cause the apparatus to perform a method of any of aspects 1 through 17.

Aspect 26: An apparatus for wireless communications at a UE, comprising at least one means for performing a method of any of aspects 1 through 17.

Aspect 27: A non-transitory computer-readable medium storing code for wireless communications at a UE, the code comprising instructions executable by a processor to perform a method of any of aspects 1 through 17.

Aspect 28: An apparatus for wireless communications at a distributed unit, comprising a processor; memory coupled with the processor; and instructions stored in the memory and executable by the processor to cause the apparatus to perform a method of any of aspects 18 through 24.

Aspect 29: An apparatus for wireless communications at a distributed unit, comprising at least one means for performing a method of any of aspects 18 through 24.

Aspect 30: A non-transitory computer-readable medium storing code for wireless communications at a distributed unit, the code comprising instructions executable by a processor to perform a method of any of aspects 18 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
communicating, via a distributed unit, a first service message to establish a first transport radio bearer with a first transport service offered by a service-based network, the first service message indicating one or more attributes associated with information to be transported via the first transport radio bearer;
receiving, from the distributed unit in response to the first service message, a physical resource configuration for communications associated with the first transport service, and a mapping of the first transport radio bearer to a first channel between the UE and the distributed unit; and
communicating, via the distributed unit based at least in part on the physical resource configuration, the information to be transported via the first transport service.

2. The method of claim 1, further comprising:
mapping one or more transport radio bearers to the first channel, each of the transport radio bearers having an associated transport service.

3. The method of claim 1, wherein the information to be transported via the first transport service is split over two or more channels between the UE and the distributed unit, including a separate channel for signaling information.

4. The method of claim 3, wherein the split over the two or more channels is based at least in part on one or more of a traffic priority of the information to be transported via the first transport service, a traffic delay tolerance of the information to be transported via the first transport service, a traffic acceptable error rate of the information to be transported via the first transport service, or any combinations thereof.

5. The method of claim 1, wherein:
two or more transport radio bearers from the first transport service are mapped to the first channel, one transport radio bearer is mapped to the first channel, or multiple transport radio bearers are mapped to each of two or more channels.

6. The method of claim 1, wherein the first service message includes one or more quality of service targets associated with the information to be transported via the first transport service, and wherein different quality of service targets are associated with different channels between the UE and the distributed unit.

7. The method of claim 1, wherein the information to be transported via the first transport service is transmitted using a plurality of packets, and each packet of the plurality of packets include an indication of the first transport radio bearer.

8. The method of claim 1, wherein the first transport radio bearer provides communications for both signaling information and data associated with the first transport service.

9. The method of claim 1, wherein the communicating the first service message comprises:
communicating the one or more attributes associated with information to be transported via the first transport service as one or more quality of service parameters that include a latency target, a throughput target, a security level, or any combinations thereof.

10. The method of claim 1, further comprising:
communicating, via the distributed unit, one or more buffer status reports to the first transport service to maintain an active state at the first transport service.

11. The method of claim 1, further comprising:
receiving an indication to throttle information to be transported via the first transport service; and
throttling the information communicated via the first transport service independently of an amount of information communicated via one or more other transport services that are different than the first transport service.

12. The method of claim 1, further comprising:
communicating, via the distributed unit, a second service message that indicates to deactivate the first transport radio bearer associated with the first transport service.

13. The method of claim 12, further comprising:
obtaining, subsequent to a deactivation of the first transport service, further information to be transported via the first transport radio bearer; and
communicating, via the distributed unit, a third service message to activate the first transport radio bearer.

14. The method of claim 13, wherein the third service message includes an indication of one or more of a buffer status report associated with the first transport radio bearer, a target delivery time for a first packet of data of the further information to be transported via the first transport radio bearer, or any combinations thereof.

15. The method of claim 1, further comprising:
communicating, via the distributed unit, a second service message that indicates to release the first transport radio bearer associated with the first transport service, wherein the second service message is communicated responsive to a lack of information to be transported via the first transport radio bearer, an expiration of data associated with the first transport radio bearer, or any combinations thereof.

16. The method of claim 1, further comprising:
receiving, from the distributed unit in response to an updated configuration associated with the first transport service, an updated physical resource configuration; and
communicating, via the distributed unit based at least in part on the updated physical resource configuration, the information to be transported via the first transport service.

17. The method of claim 1, wherein the first transport service is provided at a protocol layer associated with the first transport radio bearer, and wherein the protocol layer is an Internet protocol (IP) layer or a packet data convergence protocol (PDCP) layer.

18. A method for wireless communications at a distributed unit, comprising:
communicating a first service message between a user equipment (UE) and a first transport service offered by a service-based network, the first service message to establish the first transport service and indicating one or more attributes associated with information to be transported via the first transport service;
receiving a radio access network configuration from the first transport service that indicates a first transport radio bearer and traffic flow information associated with the first transport radio bearer;
transmitting, to the UE in response to the radio access network configuration, a physical resource configuration for communications associated with the first transport service, and a mapping of the first transport radio bearer to a first channel between the UE and the distributed unit; and
communicating, based at least in part on the physical resource configuration, the information to be transported via the first transport service between the UE and the first transport service.

19. The method of claim 18, further comprising:
mapping the first transport radio bearer and at least one other transport radio bearer to the first channel, each transport radio bearer having an associated transport service.

20. The method of claim 18, wherein the first service message includes one or more quality of service targets associated with the information to be transported via the first transport service.

21. The method of claim 18, wherein the information to be transported via the first transport service is transmitted using a plurality of packets, and each packet of the plurality of packets include an indication of the first transport radio bearer.

22. The method of claim 18, wherein the first transport radio bearer provides communications for both signaling information and data associated with the first transport service.

23. The method of claim 18, further comprising:
aggregating traffic flow information across the first transport service and one or more other transport services; and
configuring one or more carriers and one or more resource grants of the physical resource configuration based at least in part on aggregated traffic flow information.

24. The method of claim 18, further comprising:
communicating with the first transport service based at least in part on a communication protocol that provides an indication of the first transport radio bearer for each of a plurality of packets associated with the first transport radio bearer, and that provides an indication of traffic flow information associated with the first transport radio bearer.

25. A method for wireless communications at a core network service offered by a service-based network, comprising:
communicating, via a distributed unit, a first service message with a user equipment (UE) to establish a first transport radio bearer with a first transport service offered by the service-based network, the first service message indicating one or more attributes associated with information to be transported via the first transport radio bearer;
outputting a second service message to the distributed unit that indicates a radio access network configuration for the first transport radio bearer and traffic flow information associated with the first transport radio bearer; and
communicating, via the distributed unit, the information to be transported via the first transport service using the first transport radio bearer.

26. The method of claim 25, wherein the first service message includes one or more quality of service targets associated with the information to be transported via the first transport service.

27. The method of claim 25, wherein the information to be transported via the first transport service is transmitted using a plurality of packets, and each packet of the plurality of packets include an indication of the first transport radio bearer.

28. The method of claim 25, further comprising:
providing an updated radio access network configuration to the distributed unit that indicates updated traffic flow information associated with the first transport radio bearer; and
communicating with the UE, via the distributed unit, using the first transport radio bearer based at least in part on the updated radio access network configuration.

29. An apparatus for wireless communications at a user equipment (UE), comprising:
a processor;
memory coupled with the processor; and
instructions stored in the memory and executable by the processor to cause the apparatus to:
communicate, via a distributed unit, a first service message to establish a first transport radio bearer with a first transport service offered by a service-based network, the first service message indicating one or more attributes associated with information to be transported via the first transport radio bearer;
receive, from the distributed unit in response to the first service message, a physical resource configuration for communications associated with the first transport service, and a mapping of the first transport radio bearer to a first logical channel between the UE and the distributed unit; and
communicate, via the distributed unit based at least in part on the physical resource configuration, the information to be transported via the first transport service.

30. The apparatus of claim 29, wherein the instructions are further executable by the processor to cause the apparatus to:
map one or more transport radio bearers to the first channel, each of the transport radio bearers having an associated transport service.
